(19) United States
(12) Patent Application Publication
(10) Pub. No.: US 2017/0160911 A1
(43) Pub. Date: Jun. 8, 2017

(54) METHOD FOR CONTROLLING USER INTERFACE RELATED TO OBJECT AND ELECTRONIC DEVICE FOR THE SAME

(71) Applicant: Samsung Electronics Co., Ltd., Gyeonggi-do (KR)

(72) Inventors: Ji Young HO, Gyeonggi-do (KR); Kyeong Lee, Gyeonggi-do (KR); Wan-Hyoung Lee, Gyeonggi-do (KR)

(73) Assignee: Samsung Electronics Co., Ltd.

(21) Appl. No.: 15/354,353

(22) Filed: Nov. 17, 2016

(30) Foreign Application Priority Data
Dec. 4, 2015 (KR) 10-2015-0172256

(51) Int. Cl. G06F 3/0484; G06F 3/0346

(52) U.S. Cl. CPC G06F 3/04845; G06F 3/04847; G06F 3/0346; G06F 3/04883

(57) ABSTRACT

An electronic device and a method thereof are provided. The electronic device includes a memory, a display, and a processor configured to detect a connection of an object, detect a motion of an object connector connected with the object, process a user interface corresponding to the motion, and display the user interface on the display.

### PRIORITY

This application claims priority under 35 U.S.C. §119(a) to Korean Patent Application Serial No. 10-2015-0172256, which was filed in the Korean Intellectual Property Office on December 4, 2015, the entire disclosure of which is incorporated herein by reference.

### BACKGROUND

### 1. Field of the Disclosure

The present disclosure generally relates to a method and an apparatus for controlling a user interface related to an object.

### 2. Description of the Related Art

With the recent development of digital technology, various types of electronic devices, such as a mobile communication terminal, a personal digital assistant (PDA), an electronic scheduler, a smart phone, a tablet personal computer (PC), a wearable device, and the like, are widely used. Such an electronic device is provided with various functions such as a voice call, message transmission such as a short message service (SMS)/multimedia message service (MMS), a video call, an electronic scheduler, image capturing, emailing, broadcast reproduction, Internet access, music playback, schedule management, a social networking service (SNS), a messenger, photos, games, and the like.

When the electronic device is connected to an accessory such as a case accessory, an insertion type accessory, and the like, the electronic device may display a user interface related to the accessory on a display. However, the electronic device may just display an object (for example, a character image, a specific content, and the like) related to the accessory on a screen, and does not display an interaction related to the object. The electronic device displays the user interface related to the accessory connected thereto. For example, the user interface displays an object related to the accessory and is not changed according to a state of the accessory connected to the electronic device. In addition, when one or more accessories are connected to the electronic device, the electronic device may not combine the accessories such that it cannot display a single integrated user interface. In addition, the electronic device cannot recognize that various accessories are connected in sequence or simultaneously.

### SUMMARY

According to an aspect of the present disclosure, a method and an apparatus provide an object connector for connecting an object to an electronic device, such that the electronic device recognizes that an object is connected through the object connector and changes and displays a user interface according to a motion of the object connector.

In accordance with an aspect of the present disclosure an electronic device includes a memory, a display, and a processor functionally connected with the memory or the display, and wherein the processor is configured to detect a connection of an object, detect a motion of an object connector connected with the object, process a user interface corresponding to the motion, and display the user interface on the display.

In accordance with another aspect of the present disclosure, a method for operating an electronic device includes detecting a connection of an object, detecting a motion of an object connector connected with the object, and processing a user interface corresponding to the detected motion and displaying the user interface on a display. According to various exemplary embodiments, the object connector for connecting an object is provided, such that it is recognized that an object is connected through the object connector and a user interface is changed and displayed according to a motion of the object connector.

According to various exemplary embodiments, a change in the motion of the object connector is detected and a corresponding user interface is displayed according to the detected change in the motion, such that an interaction can be provided according to an object.

According to various exemplary embodiments, the electronic device can process and display a user interface related to an object by interworking with another electronic device according to a user input

### BRIEF DESCRIPTION OF THE DRAWINGS

These and other aspects, advantages and features of the present disclosure will become apparent to those skilled in the art from the following description taken in conjunction with the accompanying drawings, in which:

FIG. 1 illustrates an electronic device in a network environment according to an embodiment of the present disclosure;

FIG. 2 illustrates a block diagram of an electronic device according to an embodiment of the present disclosure;

FIG. 3 illustrates a block diagram of a program module according to an embodiment of the present disclosure;

FIGS. 4A to 4E illustrate views of fastening structures of an electronic device according to an embodiment of the present disclosure;

FIG. 5 illustrates a flowchart of an operation method of an electronic device according to an embodiment of the present disclosure;

FIG. 6 illustrates a flowchart of a method for controlling a user interface according to a change in a motion according to an embodiment of the present disclosure;

FIG. 7 illustrates flowcharts of methods for detecting a motion according to a fastening structure of an object connector according to an embodiment of the present disclosure;

FIGS. 8A to 8D illustrate views of detecting a motion in an electronic device of an insertion type fastening structure according to an embodiment of the present disclosure;

FIGS. 9A to 9C illustrate views of detecting a motion in an electronic device of a folding type fastening structure according to an embodiment of the present disclosure;

FIGS. 10A and 10B illustrate views of displaying a user interface in the electronic device of the insertion type fastening structure according to an embodiment of the present disclosure;

FIGS. 11A and 11B illustrate views of displaying a user interface in the electronic device of the folding type fastening structure according to an embodiment of the present disclosure;

FIG. 12 illustrates a flowchart of an operation of processing a user interface in an electronic device according to an embodiment of the present disclosure;

FIG. 13 illustrates a view of an operation of determining a target object for detecting a motion according to a content in an electronic device according to an embodiment of the present disclosure;

FIGS. 14A to 14C illustrate views of applying an effect related to an object to a content in an electronic device according to an embodiment of the present disclosure;

FIGS. 15A and 15B illustrate views of displaying a user interface according to a change in an object in an electronic device according to an embodiment of the present disclosure;

FIGS. 16A and 16B illustrate views of displaying a user interface according to a pen insertion in an electronic device according to an embodiment of the present disclosure; and

FIGS. 17A and 17B illustrate views of showing a visual effect using a light emitting diode (LED) in an electronic device of a fixed type fastening structure according to an embodiment of the present disclosure.

### DETAILED DESCRIPTION

Hereinafter, various embodiments of the present disclosure will be described with reference to the accompanying drawings. However, it should be understood that there is no limiting the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expressions “have”, “may have”, “include”, or “may include” refer to the existence of a corresponding feature (e.g., numeral, function, operation, or constituent element such as component), and do not exclude one or more additional features.

In the present disclosure, the expressions “A or B”, “at least one of A or/and B”, or “one or more of A or/and B” may include all possible combinations of the items listed. For example, the expressions “A or B”, “at least one of A and B”, or “at least one of A or B” refer to all of (1) including at least one A, (2) including at least one B, or (3) including all of at least one A and at least one B. The expressions “a first”, “a second”, “the first”, or “the second” as used in various embodiments of the present disclosure may modify various components regardless of the order and/or the importance but do not limit the corresponding components. For example, a first user device and a second user device indicate different user devices although both of them are user devices. For example, a first element may be referred to as a second element, and similarly, a second element may be referred to as a first element without departing from the scope of the present disclosure.

It should be understood that when an element (e.g., first element) is referred to as being (operatively or communicatively) “connected,” or “coupled,” to another element (e.g., second element), it may be directly connected or coupled to the other element or any other element (e.g., third element) may be interposed between them. In contrast, it may be understood that when an element (e.g., first element) is referred to as being “directly connected,” or “directly coupled” to another element (second element), there are no elements (e.g., third element) interposed between them.

The expression “configured to” as used in the present disclosure may be used interchangeably with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a general-purpose processor (e.g., central processing unit (CPU) or application processor (AP)) that may perform the corresponding operations by executing one or more software programs stored in a memory device.

The terms used in the present disclosure are only used to describe specific embodiments, and do not limit the present disclosure. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the same meanings as the contextual meanings in the relevant field of art, and are not to be interpreted to have ideal or excessively formal meanings unless clearly defined in the present disclosure. In some cases, even terms defined in the present disclosure should not be interpreted to exclude embodiments of the present disclosure.

An electronic device according to various embodiments of the present disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a MPEG-1 audio layer-3 (MP3) player, a mobile medical device, a camera, and a wearable device. The wearable device may include at least one of an accessory type (e.g., a watch, a ring, a bracelet, an anklet, a necklace, eyeglasses, a contact lens, or a head-mounted device (HMD)), a fabric or clothing integrated type (e.g., an electronic clothing), a body-mounted type (e.g., a skin pad, or tattoo), and a bio-implantable type (e.g., an implantable circuit).

According to an embodiment of the present disclosure, the electronic device may be a home appliance. The home appliance may include at least one of, for example, a television, a digital video disk (DVD) player, an audio player, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to an embodiment of the present disclosure, the electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a Global Positioning System (GPS) receiver, an event data recorder (EDR), a flight data recorder (FDR), a vehicle infotainment devices, an electronic device for a ship (e.g., a navigation device for a ship, and a gyro-compass), avionics, security devices, an automotive head unit, a robot for home or industry, an automatic teller machine (ATM), point of sales (POS) terminal, or an Internet of things (IoT) device (e.g., a light bulb, various sensors, electric or gas meter, a sprinkler device, a fire alarm, a thermostat, a streetlamp, a toaster, a sporting good, a hot water tank, a heater, a boiler, etc.).

According to an embodiment of the present disclosure, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device may be a combination of one or more of the aforementioned various devices. The electronic device may be a flexible device. Further, the electronic device is not limited to the aforementioned devices, and may include a new electronic device according to the development of new technology.

Hereinafter, an electronic device according to an embodiment of the present disclosure will be described with reference to the accompanying drawings. As used herein, the term “user” may indicate a person who uses an electronic device or a device (e.g., an artificial intelligence electronic device) that uses an electronic device.

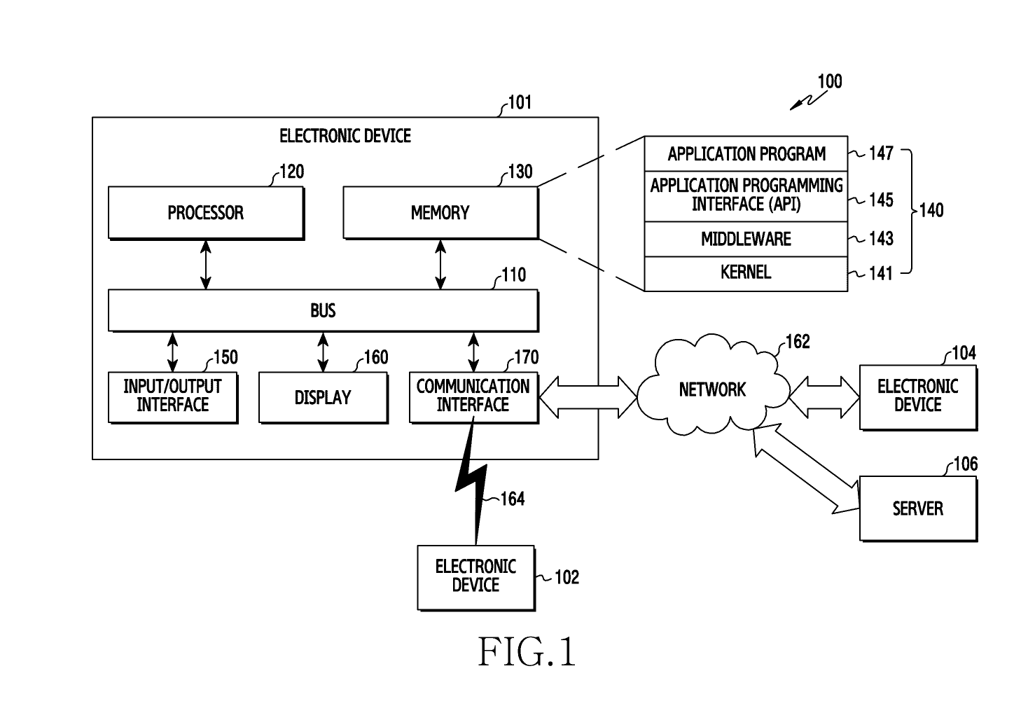

FIG. 1 illustrates a network environment including an electronic device according to various embodiments of the present disclosure.

An electronic device 101 within a network environment 100, will be described with reference to FIG. 1. The electronic device 101 includes a bus 110, a processor 120, a memory 130, an input/output interface 150, a display 160, and a communication interface 170. According to an embodiment of the present disclosure, the electronic device 101 may omit at least one of the above components or may further include other components.

The bus 110 may include, for example, a circuit which interconnects the components 110 to 170 and delivers a communication (e.g., a control message and/or data) between the components 110 to 170.

The processor 120 may include one or more of a central processing unit (CPU), an application processor (AP), and a communication processor (CP). The processor 120 may carry out, for example, calculation or data processing relating to control and/or communication of at least one other component of the electronic device 101.

The memory 130 may include a volatile memory and/or a non-volatile memory. The memory 130 may store, for example, commands or data relevant to at least one other component of the electronic device 101. According to an embodiment of the present disclosure, the memory 130 may store software and/or a program 140. The program 140 includes, for example, a kernel 141, middleware 143, an application programming interface (API) 145, and/or application programs (or “applications”) 147. At least some of the kernel 141, the middleware 143, and the API 145 may be referred to as an operating system (OS).

The kernel 141 may control or manage system resources (e.g., the bus 110, the processor 120, or the memory 130) used for performing an operation or function implemented in the other programs (e.g., the middleware 143, the API 145, or the application programs 147). Furthermore, the kernel 141 may provide an interface through which the middleware 143, the API 145, or the applications 147 may access the individual components of the electronic device 101 to control or manage the system resources.

The middleware 143, for example, may serve as an intermediary for allowing the API 145 or the applications 147 to communicate with the kernel 141 to exchange data.

The middleware 143 may process one or more task requests received from the applications 147 according to priorities thereof. For example, the middleware 143 may assign priorities for using the system resources (e.g., the bus 110, the processor 120, the memory 130, and the like) of the electronic device 101, to at least one of the applications 147. For example, the middleware 143 may perform scheduling or loading balancing on the one or more task requests by processing the one or more task requests according to the priorities assigned thereto.

The API 145 is an interface through which the applications 147 control functions provided from the kernel 141 or the middleware 143, and may include, for example, at least one interface or function (e.g., instruction) for file control, window control, image processing, character control, and the like.

The input/output interface 150, for example, may function as an interface that may transfer commands or data input from a user or another external device to the other element(s) of the electronic device 101. Furthermore, the input/output interface 150 may output the commands or data received from the other element(s) of the electronic device 101 to the user or another external device.

Examples of the display 160 may include a liquid crystal display (LCD), a light-emitting diode (LED) display, an organic light-emitting diode (OLED) display, a microelectromechanical systems (MEMS) display, and an electronic paper display. The display 160 may display, for example, various types of content (e.g., text, images, videos, icons, or symbols) to users. The display 160 may include a touch screen, and may receive, for example, a touch, gesture, proximity, or hovering input using an electronic pen or a user's body part.

The communication interface 170 may establish communication, for example, between the electronic device 101 and a first external electronic device 102, a second external electronic device 104, or a server 106. For example, the communication interface 170 may be connected to a network 162 through wireless or wired communication, and may communicate with the second external electronic device 104 or the server 106. The wireless communication may use at least one of, for example, long term evolution (LTE), LTE-Advance (LTE-A), code division multiple access (CDMA), wideband CDMA (WCDMA), universal mobile telecommunications system (UMTS), wireless broadband (WiBro), and global system for mobile communications (GSM), as a cellular communication protocol. In addition, the wireless communication may include, for example, short range communication 164. The short-range communication 164 may include at least one of, for example, Wi-Fi, Bluetooth, near field communication (NFC), and global navigation satellite system (GNSS). GNSS may include, for example, at least one of global positioning system (GPS), global navigation satellite system (Glonass), Beidou navigation satellite system (Beidou) or Galileo, and the European global satellite-based navigation system, based on a location, a bandwidth, and the like. Hereinafter, in the present disclosure, the term “GPS” may be interchangeably used with the term “GNSS”. The wired communication may include, for example, at least one of a universal serial bus (USB), a high definition multimedia interface (HDMI), recommended standard 232 (RS-232), and a plain old telephone service (POTS). The network 162 may include at least one of a telecommunication network such as a computer network (e.g., a LAN or a WAN), the Internet, and a telephone network.

Each of the first and second external electronic devices 102 and 104 may be of a type identical to or different from that of the electronic device 101. According to an embodiment of the present disclosure, the server 106 may include a group of one or more servers. All or some of the operations performed in the electronic device 101 may be executed in another electronic device or the electronic devices 102 and 104 or the server 106. When the electronic device 101 has to perform some functions or services automatically or in response to a request, the electronic device 101 may request the electronic device 102 or 104 or the server 106 to execute at least some functions relating thereto instead of or in addition to autonomously performing the functions or services. The electronic device 102 or 104, or the server 106 may execute the requested functions or the additional functions, and may deliver a result of the execution to the electronic device 101. The electronic device 101 may process the received result as it is or additionally, and may provide the requested functions or services. To this end, for example, cloud computing, distributed computing, or client-server computing technologies may be used.

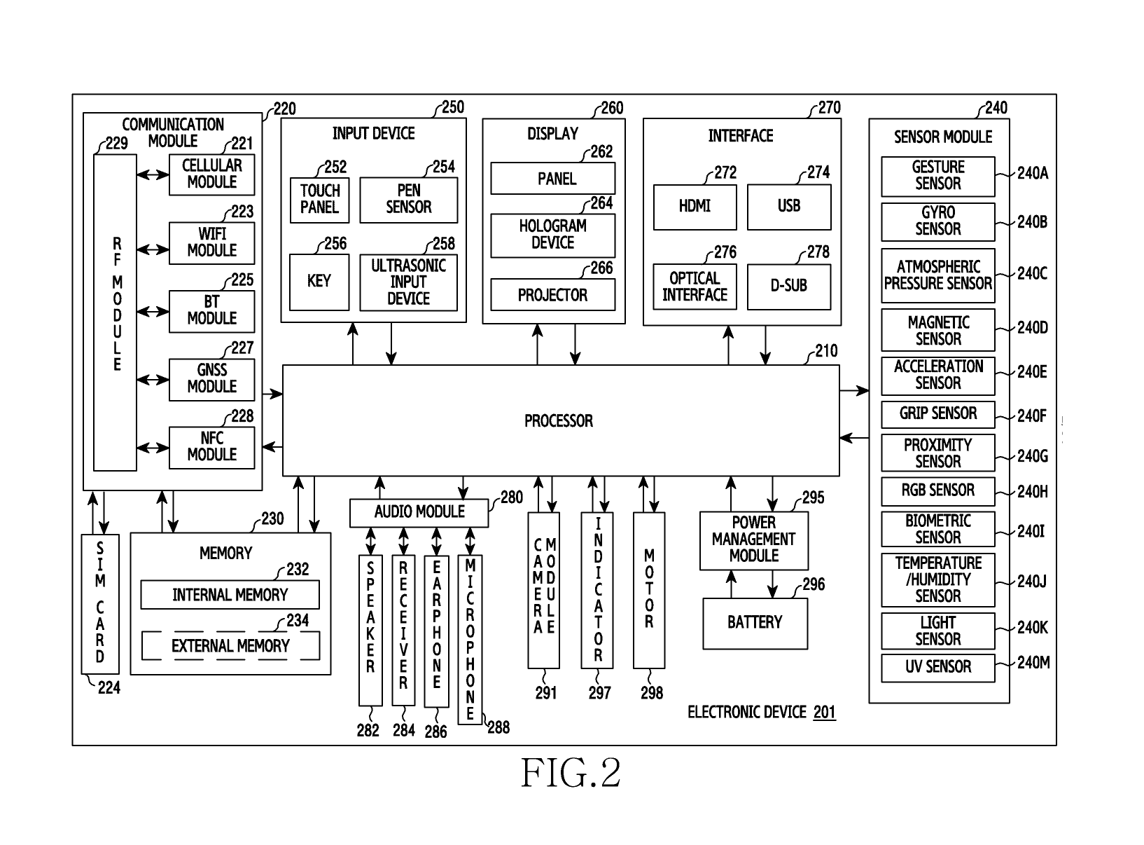

FIG. 2 is a block diagram of an electronic device according to an embodiment of the present disclosure.

The electronic device 201 may include, for example, all or a part of the electronic device 101 shown in FIG. 1. The electronic device 201 includes one or more processors 210 (e.g., application processors (AP)), a communication module 220, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an operating system or an application program, and perform processing of various pieces of data and calculations. The processor 210 may be embodied as, for example, a system on chip (SoC). According to an embodiment of the present disclosure, the processor 210 may further include a graphic processing unit (GPU) and/or an image signal processor. The processor 210 may include at least some (e.g., a cellular module 221) of the components illustrated in FIG. 2. The processor 210 may load, into a volatile memory, commands or data received from at least one (e.g., a non-volatile memory) of the other components and may process the loaded commands or data, and may store various data in a non-volatile memory.

The communication module 220 may have a configuration equal or similar to that of the communication interface 170 of FIG. 1. The communication module 220 includes, for example, a cellular module 221, a Wi-Fi module 223, a BT module 225, a GNSS module 227 (e.g., a GPS module, a Glonass module, a Beidou module, or a Galileo module), an NFC module 228, and a radio frequency (RF) module 229.

The cellular module 221, for example, may provide a voice call, a video call, a text message service, or an Internet service through a communication network. According to an embodiment of the present disclosure, the cellular module 221 may distinguish and authenticate the electronic device 201 in a communication network using a subscriber identification module (SIM) 224. The cellular module 221 may perform at least some of the functions that the AP 210 may provide. The cellular module 221 may include a communication processor (CP).

For example, each of the Wi-Fi module 223, the BT module 225, the GNSS module 227, and the NFC module 228 may include a processor for processing data transmitted/received through a corresponding module. According to an embodiment of the present disclosure, at least some (e.g., two or more) of the cellular module 221, the Wi-Fi module 223, the BT module 225, the GNSS module 227, and the NFC module 228 may be included in one integrated chip (IC) or IC package.

The RF module 229, for example, may transmit/receive a communication signal (e.g., an RF signal). The RF module 229 may include, for example, a transceiver, a power amplifier module (PAM), a frequency filter, a low noise amplifier (LNA), and an antenna. According to another embodiment of the present disclosure, at least one of the cellular module 221, the WIFI module 223, the BT module 225, the GNSS module 227, and the NFC module 228 may transmit/receive an RF signal through a separate RF module.

The SIM 224 may include, for example, a card including a subscriber identity module and/or an embedded SIM, and may contain unique identification information (e.g., an integrated circuit card identifier (ICCID)) or subscriber information (e.g., an international mobile subscriber identity (IMSI)).

The memory 230 (e.g., the memory 130) includes, for example, an embedded memory 232 or an external memory 234. The embedded memory 232 may include at least one of a volatile memory (e.g., a dynamic random access memory (DRAM), a static RAM (SRAM), a synchronous dynamic RAM (SDRAM), and the like) and a non-volatile memory (e.g., a one time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory), a hard disc drive, a solid state drive (SSD), and the like).

The external memory 234 may further include a flash drive, for example, a compact flash (CF), a secure digital (SD), a micro secure digital (Micro-SD), a mini secure digital (mini-SD), an eXtreme digital (xD), a multimediacard (MMC), a memory stick, and the like. The external memory 234 may be functionally and/or physically connected to the electronic device 201 through various interfaces.

The sensor module 240, for example, may measure a physical quantity or detect an operation state of the electronic device 201, and may convert the measured or detected information into an electrical signal. The sensor module 240 includes, for example, at least one of a gesture sensor 240A, a gyro sensor 240B, an atmospheric pressure sensor (barometer) 240C, a magnetic sensor 240D, an acceleration sensor 240E, a grip sensor 240F, a proximity sensor 2406, a color sensor 240H (e.g., red, green, and blue (RGB) sensor), a biometric sensor (medical sensor) 2401, a temperature/humidity sensor 240J, an illuminance sensor 240K, and a ultra violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris scan sensor, and/or a finger scan sensor. The sensor module 240 may further include a control circuit for controlling one or more sensors included therein. The electronic device 201 may further include a processor configured to control the sensor module 240, as a part of the processor 210 or separately from the processor 210, and may control the sensor module 240 while the processor 210 is in a sleep state.

The input device 250 includes, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. The touch panel 252 may further include a control circuit. The touch panel 252 may further include a tactile layer, and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect, through a microphone 288, ultrasonic waves generated by an input tool, and identify data corresponding to the detected ultrasonic waves.

The display 260 (e.g., the display 160) includes a panel 262, a hologram device 264, or a projector 266. The panel 262 may include a configuration identical or similar to the display 160 illustrated in FIG. 1. The panel 262 may be implemented to be, for example, flexible, transparent, or wearable. The panel 262 may be embodied as a single module with the touch panel 252. The hologram device 264 may show a three dimensional (3D) image in the air by using an interference of light. The projector 266 may project light onto a screen to display an image. The screen may be located, for example, in the interior of or on the exterior of the electronic device 201. According to an embodiment of the present disclosure, the display 260 may further include a control circuit for controlling the panel 262, the hologram device 264, or the projector 266.

The interface 270 may include, for example, a high-definition multimedia interface (HDMI) 272, a universal serial bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a mobile high-definition link (MHL) interface, a secure digital (SD) card/multi-media card (MMC) interface, or an infrared data association (IrDA) standard interface.

The audio module 280, for example, may bidirectionally convert a sound and an electrical signal. At least some components of the audio module 280 may be included in, for example, the input/output interface 150 illustrated in FIG. 1. The audio module 280 may process voice information input or output through, for example, a speaker 282, a receiver 284, earphones 286, or the microphone 288.

The camera module 291 is, for example, a device which may photograph a still image and a video. According to an embodiment of the present disclosure, the camera module 291 may include one or more image sensors (e.g., a front sensor or a back sensor), a lens, an image signal processor (ISP) or a flash (e.g., LED or xenon lamp).

The power management module 295 may manage, for example, power of the electronic device 201. According to an embodiment of the present disclosure, the power management module 295 may include a power management integrated circuit (PMIC), a charger integrated circuit (IC), or a battery gauge. The PMIC may use a wired and/or wireless charging method. Examples of the wireless charging method may include, for example, a magnetic resonance method, a magnetic induction method, an electromagnetic wave method, and the like. Additional circuits (e.g., a coil loop, a resonance circuit, a rectifier, etc.) for wireless charging may be further included. The battery gauge may measure, for example, a residual charge quantity of the battery 296, and a voltage, a current, or a temperature while charging. The battery 296 may include, for example, a rechargeable battery and/or a solar battery.

The indicator 297 may display a particular state (e.g., a booting state, a message state, a charging state, and the like) of the electronic device 201 or a part (e.g., the processor 210) of the electronic device 201. The motor 298 may convert an electrical signal into a mechanical vibration, and may generate a vibration, a haptic effect, and the like. The electronic device 201 may include a processing device (e.g., a GPU) for supporting a mobile TV. The processing device for supporting a mobile TV may process, for example, media data according to a certain standard such as digital multimedia broadcasting (DMB), digital video broadcasting (DVB), or MediaFLO™.

Each of the above-described component elements of hardware may be configured with one or more components, and the names of the corresponding component elements may vary based on the type of electronic device. The electronic device may include at least one of the above-described elements. Some of the above-described elements may be omitted from the electronic device, or the electronic device may further include additional elements. Also, some of the hardware components may be combined into one entity, which may perform functions identical to those of the relevant components before the combination.

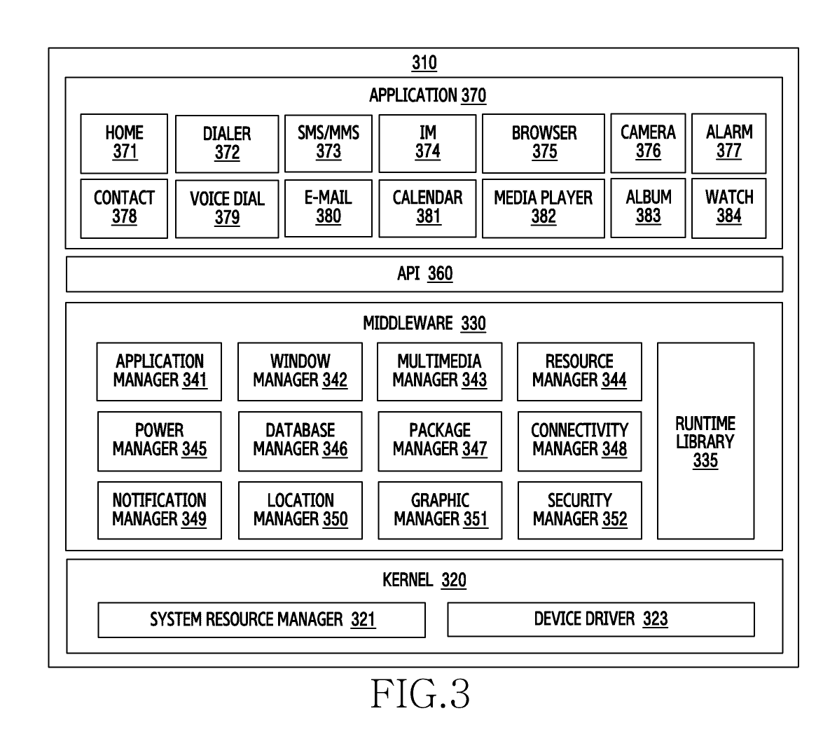

FIG. 3 is a block diagram of a program module according to an embodiment of the present disclosure.

According to an embodiment of the present disclosure, the program module 310 (e.g., the program 140) may include an operating system (OS) for controlling resources related to the electronic device 101 and/or various applications (e.g., the application programs 147) executed in the operating system. The operating system may be, for example, Android™, iOS™, Windows™, Symbian™, Tizen™, Bada™, and the like.

The program module 310 includes a kernel 320, middleware 330, an API 360, and/or applications 370. At least some of the program module 310 may be preloaded on an electronic device, or may be downloaded from the electronic device 102 or 104, or the server 106.

The kernel 320 (e.g., the kernel 141) includes, for example, a system resource manager 321 and/or a device driver 323. The system resource manager 321 may control, allocate, or collect system resources. According to an embodiment of the present disclosure, the system resource manager 321 may include a process management unit, a memory management unit, a file system management unit, and the like. The device driver 323 may include, for example, a display driver, a camera driver, a Bluetooth driver, a shared memory driver, a USB driver, a keypad driver, a Wi-Fi driver, an audio driver, or an inter-process communication (IPC) driver.

For example, the middleware 330 may provide a function required in common by the applications 370, or may provide various functions to the applications 370 through the API 360 so as to enable the applications 370 to efficiently use the limited system resources in the electronic device. According to an embodiment of the present disclosure, the middleware 330 (e.g., the middleware 143) includes at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while an application 370 is being executed. The runtime library 335 may perform input/output management, memory management, the functionality for an arithmetic function, and the like.

The application manager 341 may manage, for example, a life cycle of at least one of the applications 370. The window manager 342 may manage graphical user interface (GUI) resources used by a screen. The multimedia manager 343 may recognize a format required for reproduction of various media files, and may perform encoding or decoding of a media file by using a codec suitable for the corresponding format. The resource manager 344 may manage resources of a source code, a memory, and a storage space of at least one of the applications 370.

The power manager 345 may operate together with, for example, a basic input/output system (BIOS) and the like to manage a battery or power source and may provide power information and the like required for the operations of the electronic device. The database manager 346 may generate, search for, and/or change a database to be used by at least one of the applications 370. The package manager 347 may manage installation or an update of an application distributed in a form of a package file.

For example, the connectivity manager 348 may manage wireless connectivity such as Wi-Fi or Bluetooth. The notification manager 349 may display or notify of an event such as an arrival message, promise, proximity notification, and the like in such a way that does not disturb a user. The location manager 350 may manage location information of an electronic device. The graphic manager 351 may manage a graphic effect which will be provided to a user, or a user interface related to the graphic effect. The security manager 352 may provide all security functions required for system security, user authentication, and the like. According to an embodiment of the present disclosure, when the electronic device 101 has a telephone call function, the middleware 330 may further include a telephony manager for managing a voice call function or a video call function of the electronic device.

The middleware 330 may include a middleware module that forms a combination of various functions of the above-described components. The middleware 330 may provide a module specialized for each type of OS in order to provide a differentiated function. Further, the middleware 330 may dynamically remove some of the existing components or add new components.

The API 360 (e.g., the API 145) is, for example, a set of API programming functions, and may be provided with a different configuration according to an OS. For example, in the case of Android or iOS, one API set may be provided for each platform. In the case of Tizen, two or more API sets may be provided for each platform.

The applications 370 include, for example, one or more applications which may provide functions such as a home 371, a dialer 372, an SMS/MMS 373, an instant message (IM) 374, a browser 375, a camera 376, an alarm 377, contacts 378, a voice dial 379, an email 380, a calendar 381, a media player 382, an album 383, a clock 384, health care (e.g., measuring exercise quantity or blood sugar level), or environment information (e.g., providing atmospheric pressure, humidity, or temperature information).

According to an embodiment of the present disclosure, the applications 370 may include an information exchange application that supports exchanging information between the electronic device 101 and the electronic device 102 or 104. The information exchange application may include, for example, a notification relay application for transferring specific information to an external electronic device or a device management application for managing an external electronic device.

For example, the notification relay application may include a function of transferring, to the electronic device 102 or 104, notification information generated from other applications of the electronic device 101 (e.g., an SMS/MMS application, an e-mail application, a health management application, or an environmental information application). Further, the notification relay application may receive notification information from, for example, an external electronic device and provide the received notification information to a user.

The device management application may manage (e.g., install, delete, or update), for example, at least one function of the electronic device 102 or 104 communicating with the electronic device (e.g., a function of turning on/off the external electronic device itself (or some components) or a function of adjusting the brightness (or a resolution) of the display), applications operating in the external electronic device, and services provided by the external electronic device (e.g., a call service or a message service).

According to an embodiment of the present disclosure, the applications 370 may include applications (e.g., a health care application of a mobile medical appliance and the like) designated according to attributes of the electronic device 102 or 104. According to an embodiment of the present disclosure, the applications 370 may include an application received from the server 106, or the electronic device 102 or 104. The applications 370 may include a preloaded application or a third party application that may be downloaded from a server. The names of the components of the program module 310 of the illustrated embodiment of the present disclosure may change according to the type of operating system.

At least a part of the programming module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

The term “module” as used herein may, for example, mean a unit including one of hardware, software, and firmware or a combination of two or more of them. The term “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an application-specific integrated circuit (ASIC) chip, a field-programmable gate arrays (FPGA), and a programmable-logic device for performing operations which has been known or are to be developed hereinafter.

At least some of the devices (e.g., modules or functions thereof) or the method (e.g., operations) may be implemented by a command stored in a non-transitory computer-readable storage medium in a programming module form. The instruction, when executed by a processor (e.g., the processor 120), may cause the one or more processors to execute the function corresponding to the instruction. The computer-readable recoding media may be, for example, the memory 130.

An electronic device which will be described below has a structure such that it may have an object (for example, a card) fastened thereto, and may provide various user interfaces regarding games, education, themes, and icon change according to the type of the fastened object. The electronic device may be the electronic device 101 shown in FIG.1 or the electronic device 201 shown in FIG. 2. The electronic device 101 will be described by way of an example of the electronic device, but the electronic device is not limited by the present disclosure. The user interface which will be described below may include a user experience.

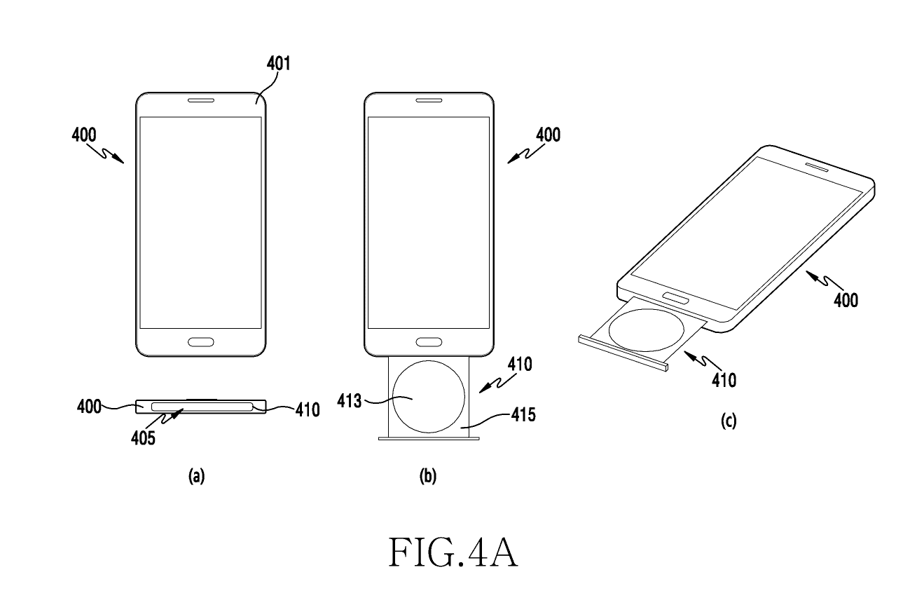

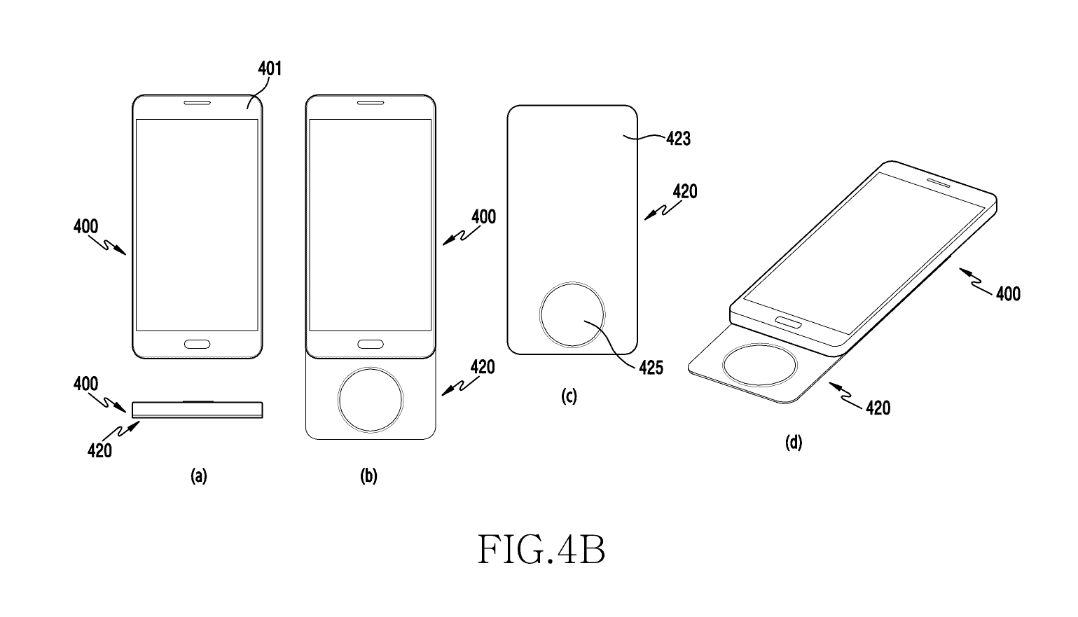

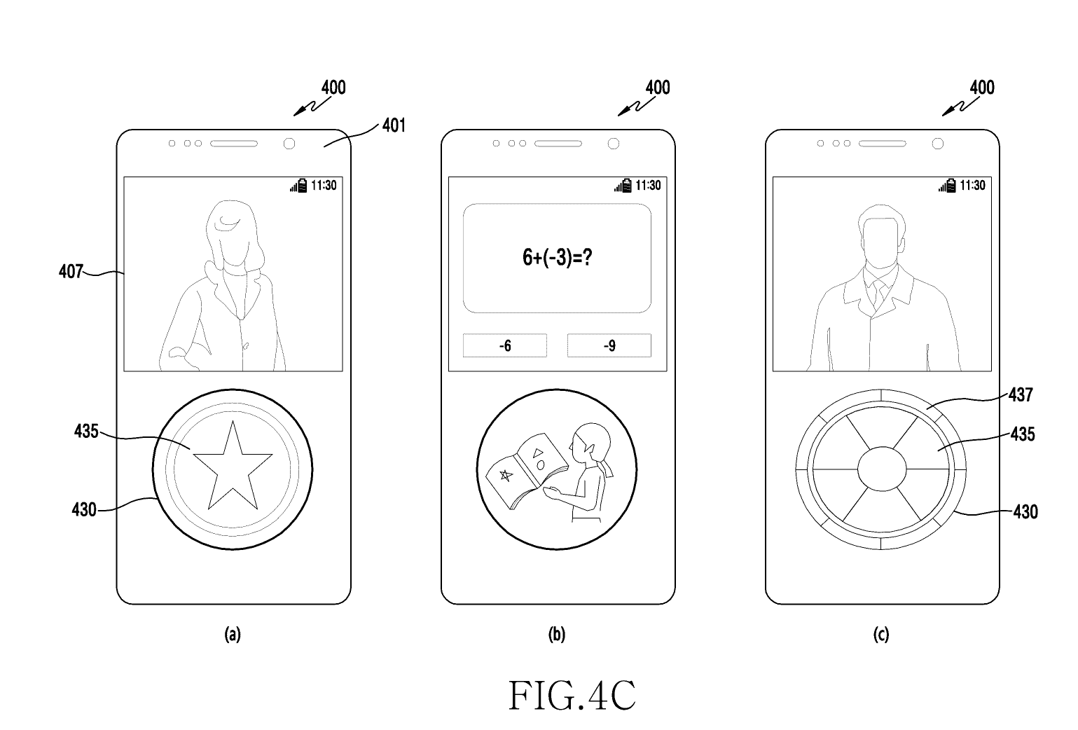

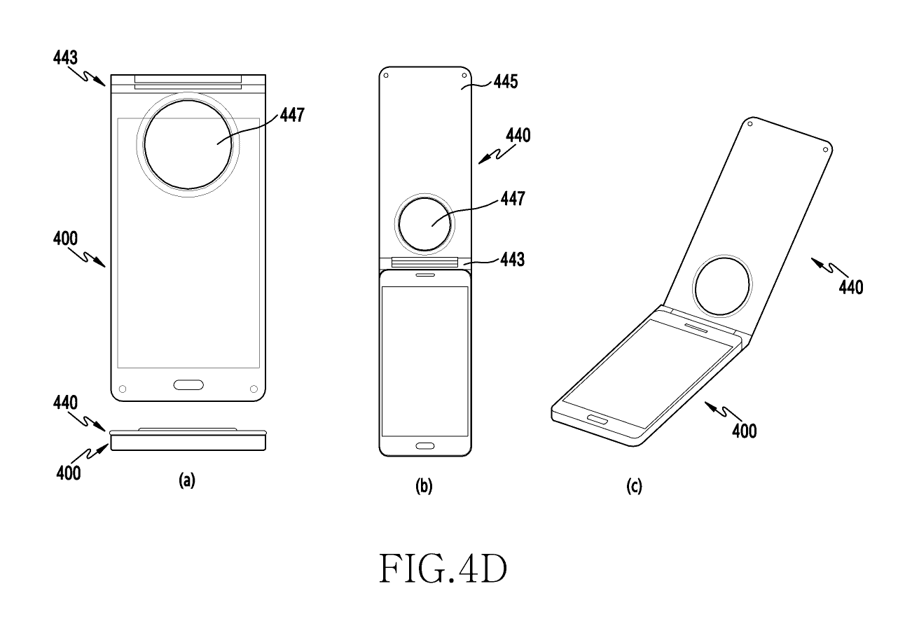

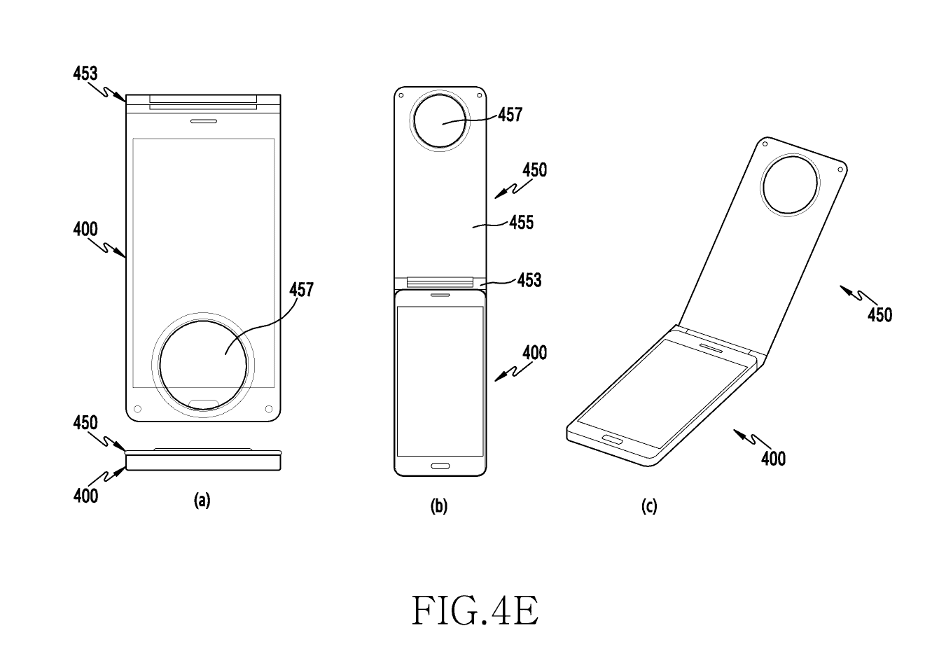

FIGS. 4A to 4E illustrate views of fastening structures of an electronic device according to an embodiment of the present disclosure.

FIG. 4A illustrates a view of an object connector of an electronic device which is implemented as an insertion type. Referring to FIG. 4A, the electronic device 400 includes a housing 401 (or a body), a connector which is assembled with the housing, a side surface bezel for connecting with a peripheral device (for example, a card or an accessory), and a hole 405 formed on the side surface of the housing to allow the object connector 410 to be inserted. Through the hole 405, the object connector 410 may be inserted into the electronic device 400. View (a) of FIG. 4A illustrates a front view and a side view when the object connector 410 is completely inserted into the electronic device 400. Referring to view (a), the electronic device 400 may include the hole 405 formed on the lower side surface of the housing to correspond to the object connector 410.

View (a) illustrates that the hole 405 is formed on the lower side surface of the housing, but the hole 405 may be formed on the upper side surface or left or right side surface of the housing. The electronic device may further include, inside the hole 405, a fastening member to which the object connector 410 is fastened, a sensor (or an interface) for detecting that an object is connected, a moving member (for example, a rail) for moving the object connector 410 to the inside of the electronic device 400, and a sensor or a detection member for detecting an insertion distance (or length) indicating how far the object connector 410 is inserted into the electronic device 400. The electronic device 400 may display a corresponding user interface differently according to the insertion distance of the object connector 410. For example, as the insertion distance increases, the electronic device 400 may increase the size of a display character related to the object.

View (b) of FIG. 4A illustrates a front view when the object connector 410 is partially fastened to the electronic device 400, and view (c) of FIG. 4A illustrates a perspective view when the object connector 410 is partially fastened to the electronic device 400. Referring to views (b) and (c), the object connector 410 may include a fastening member to be fastened to the electronic device 400, a hole 413 for mounting an object (for example, a card), a sensor (or an interface) for detecting that an object is connected, and a support member 415 for supporting the outside of the hole 413. In FIG. 4A, the hole 413 is formed in a circular shape, but the hole 413 may be formed in various shapes, such as a triangle, a rectangle, or a polygon, according to the shape of an object.

FIG. 4B illustrates a view of an object connector of an electronic device which is implemented as a slide type. Referring to FIG. 4B, the electronic device 400 may include a fastening member formed on the back surface of the housing 401 to allow the object connector 420 to be fastened thereto. View (a) of FIG. 4B illustrates a front view and a side view when the electronic device 400 and the object connector 420 are completely fastened to each other. Referring to view (a), the fastening member may be formed in a slide structure. The fastening member may further include a sensor or a detection member for detecting a slide distance indicating how far the object connector 420 is inserted into the electronic device 400.

In FIG. 4B, the fastening member is shown formed in a vertical direction, but may be formed in a horizontal direction. In FIG. 4B, the object connector 420 is shown fastened to the back surface of the housing, but the object connector 420 may be fastened to the front surface of the housing. The electronic device 400 may display a corresponding user interface differently according to a distance that the object connector 420 is inserted. For example, as the slide distance increases, the electronic device 400 may increase the size of a display character related to the object.

View (b) of FIG. 4B illustrates a front view when the object connector 420 is partially fastened to the electronic device 400, and view (d) of FIG. 4B illustrates a perspective view when the object connector 420 is partially fastened to the electronic device 400. View (c) of FIG. 4B illustrates a front view of the object connector 420. A front surface 423 of the object connector 420 may be made of transparent material and a hole 425 may be formed on a part of the front surface 423 to mount an object therein. A sensor (or an interface) may be included in the hole 425 to detect that an object is connected (or mounted). According to an embodiment of the present disclosure, the object connector 420 may be formed of opaque material when the object connector 420 is connected to the back surface of the housing. In FIG. 4B, the hole 425 is shown formed in a circular shape, but the hole 425 may be formed in various shapes such as a triangle, a rectangle, a polygon according to the shape of an object.

FIG. 4C illustrates a view of an object connector of an electronic device which is implemented as a fixed type. Referring to FIG. 4C, the electronic device 400 may form a display 407 and an object connector 430 on the front surface of the housing 401. Views (a) and (b) of FIG. 4C illustrate front views showing the electronic device 400 in which an object is mounted. Referring to views (a) and (b), the object connector 430 may be formed on the lower end of the display 407 of the electronic device 400, and may include a fixing hole 435 for mounting an object. The fixing hole 431 may be formed in a stepped structure from the front surface of the housing, and may be formed to be directly exposed to the outside. A sensor (or an interface) may be included in the fixing hole 431 to detect that an object is connected (or mounted).

Referring to views (a) and (b) of FIG. 4C, the electronic device may display a different user interface on the display 407 according to an object connected to the object connector 430. View (a) illustrates a user interface which displays an image (for example, the upper body of a woman) related to a first object on the display 407 when the first object is connected to the object connector 430. View (b) illustrates a user interface which displays a content related to education on the display 407 when an object for education is connected to the object connector 430. View (c) of FIG. 4C illustrates a front view of the electronic device 400 which further includes a light emitting diode (LED) mounting member 437 formed on the edge of the fixing hole 435. The electronic device 400 may display a battery charge level of the electronic device 400, a life gauge related to a second object mounted in the fixing hole 435, and a step of loading an image (for example, the upper body of a person) related to the second object using the LED mounting member 437.

FIG. 4D illustrates an object connector of an electronic device which is implemented as a folding type (or a flip cover type). Referring to FIG. 4D, the electronic device 400 may include a sensor or a detection member for detecting whether the object connector 440 is fastened to the electronic device 400. View (a) of FIG. 4D illustrates a front view and a side view when the object connector 440 is completely closed on the electronic device 400. Referring to view (a), the object connector 440 includes a fastening member 443 which is fastened to the side surface of the upper end of the housing of the electronic device 400, and a hole 447 formed on a part of the front surface for mounting an object therein. A sensor (or an interface) may be included in the hole 447 to detect that an object is connected (or mounted). The object connector 440 may be implemented using transparent material. In a state in which the object connector 440 completely covers the top surface of the electronic device 400, the electronic device 400 may display an area to an upper/lower line connected with the object, rather than displaying the entire screen.

In FIG. 4D, the fastening member is formed on the side surface of the upper end of the housing, but may be formed on the side surface of the lower end or left or right side surface. In addition, in FIG. 4D, the object connector 440 is fastened to the front surface of the electronic device 400, but the object connector 440 may be fastened to the back surface of the electronic device 400. The electronic device 400 may display a corresponding user interface differently according to a folding (or hinge) angle with the object connector 440. For example, the electronic device 400 may increase the size of a display character related to an object as the folding angle decreases in a similar way to the case of the insertion length or the slide distance.

View (b) of FIG. 4D illustrates a front view when the object connector 440 is partially closed on the electronic device 400, and view (c) of FIG. 4D illustrates a perspective view when the object connector 440 is partially closed on the electronic device 400. A front surface 445 of the object connector 440 may be formed of transparent material, and the object connector 440 includes the fastening member 443 formed on the side surface of the lower end of the front surface 445 to be fastened to the electronic device 400 and the hole 447 for mounting an object may be formed above the fastening member 443. According to an embodiment of the present disclosure, the object connector 440 may be formed of opaque material when the object connector 440 is fastened to the back surface of the housing. In FIG. 4D, the hole 447 is shown formed in a circular shape, but the hole 447 may be formed in various shapes such as a triangle, a rectangle, a polygon according to the shape of an object. In FIG. 4D, the electronic device 400 may use only the lower area of the display under the object as a display area, rather than displaying the front surface of the display as an entire screen.

FIG. 4E illustrates an object connector of an electronic device which is implemented as a folding type (or a flip cover type). Unlike in views (a) to (c) of FIG. 4D, in views (a) to (c) of FIG. 4E, a front surface 455 of the object connector 450 is formed of transparent material, and a hole 457 is formed on the upper end of the front surface 455, for mounting an object, and the object connector 450 may include a fastening member 453 formed on the side surface of the lower end of the front surface 455 to be fastened to the electronic device 400. Comparing FIGS. 4D and 4E, it may be seen that the hole 457 is formed on a different location of the object connector 450. Alternatively, unlike in FIGS. 4D and 4E, the hole of the object connector may be formed on the center rather than on the upper or lower end. In FIG. 4E, the electronic device 400 may use only the upper area of the display above the object as a display area, rather than displaying the front surface of the display as an entire screen.

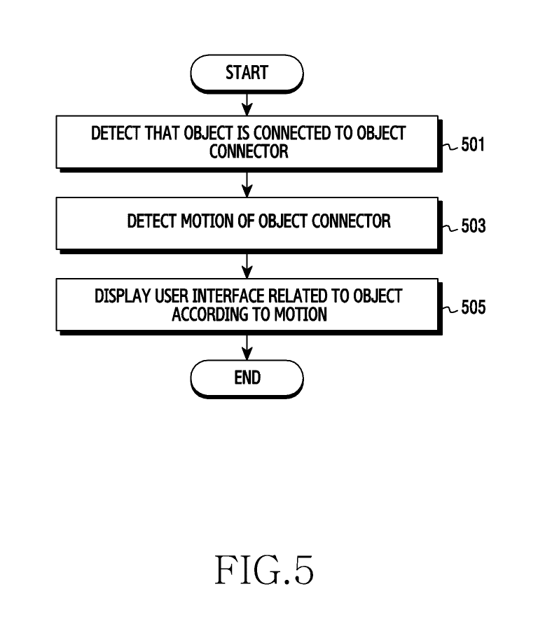

FIG. 5 illustrates a flowchart of an operation method of an electronic device according to an embodiment of the present disclosure.

Referring to FIG. 5, in step 501, the electronic device 101 (for example, the processor 120) detects whether an object is connected to an object connector (for example, the object connectors 410 to 450). The object may refer to all kinds of material which may be inserted into or connected to the electronic device 101 and used therein, such as a card, a pen, a micro SD card, a USB jack, and the like. The object connector may be formed in various shapes as shown in FIGS. 4A to 4E. However, in the flowchart of FIG. 5, the object connector 410 of FIG. 4A will be described by way of an example. The object connector 410 includes the hole 413 and may further include the sensor (or interface) formed in the hole 413 to determine whether an object is connected or mounted. When an object is mounted in the hole 413, the processor 120 may detect that the object is connected (or mounted) using the sensor.

According to an embodiment of the present disclosure, when an object approaches, the processor 120 may detect the approach of the object using a radio frequency identification (RFID) module. The object may include tag information. When the processor 120 detects the object approaching using the RFID module, the processor 120 may receive tag information from the object. The processor 120 may prepare to use content related to the object using the tag information. For example, the content may include at least one of a text, an image, a video, an icon, a symbol background screen, a home screen, or an application.

In step 503, the processor 120 detects a motion of the object connector 410. When the object is determined as being connected to the object connector 410, the processor 120 may start monitoring whether there is a motion in the object connector 410 in order to display a user interface differently according to the motion of the object connector 410. When the monitoring is started, the processor 120 may determine whether the motion of the object connector 410 occurs according to a predetermined level. For example, the predetermined level may be a distance unit or a value unit. For example, when the predetermined level is a distance unit, the predetermined level may be determined to have a constant distance (for example, 0.5 cm or 1 cm) based on the total motion distance. When a motion is detected, the processor 120 may determine whether the detected motion corresponds to the predetermined level. When a change in the motion does not correspond to the predetermined level, the processor 120 may continue detecting a change in the motion until the change reaches the predetermined level.

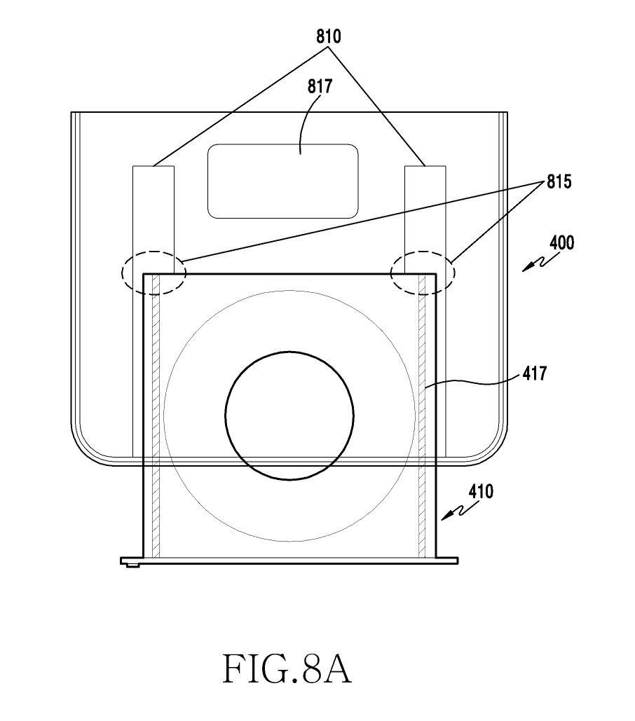

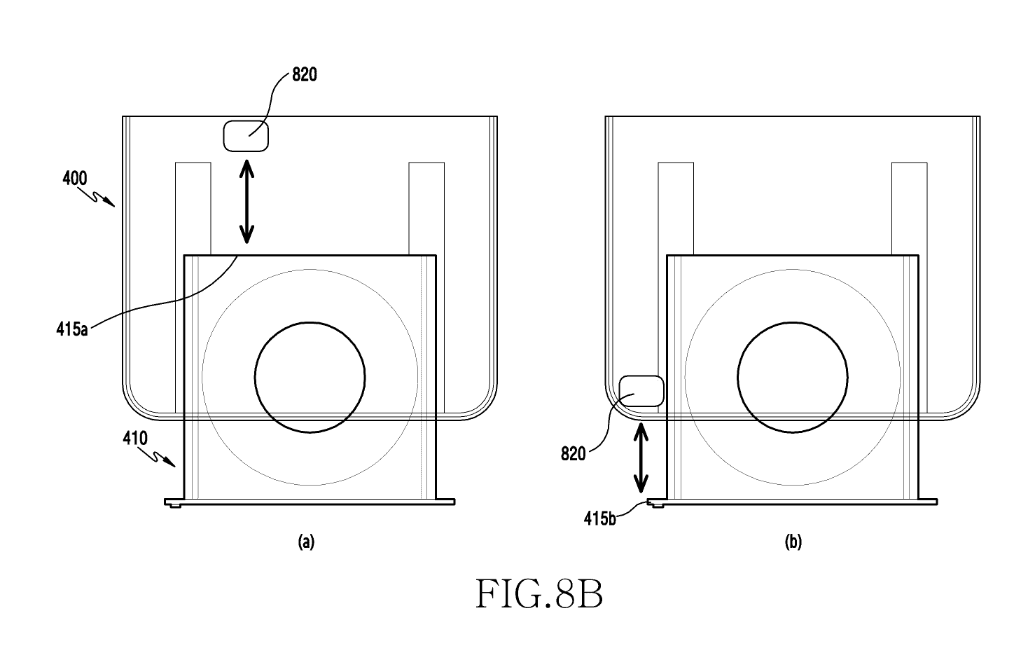

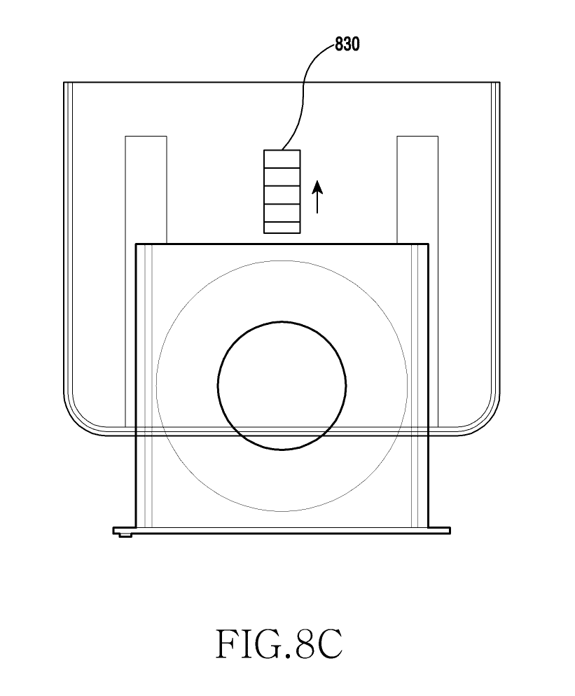

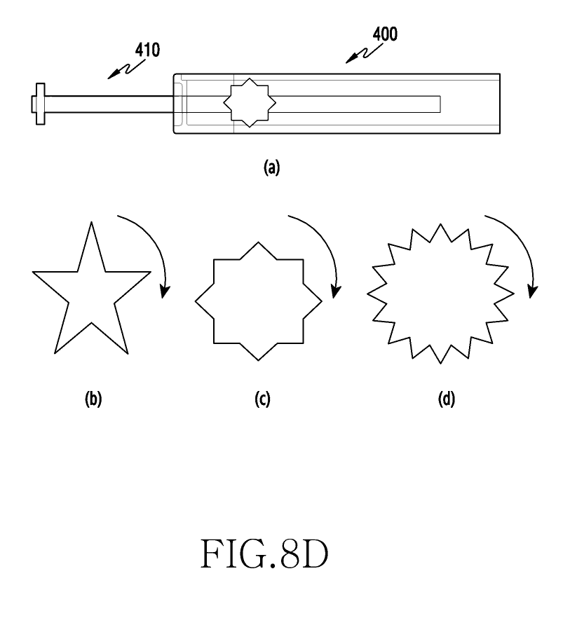

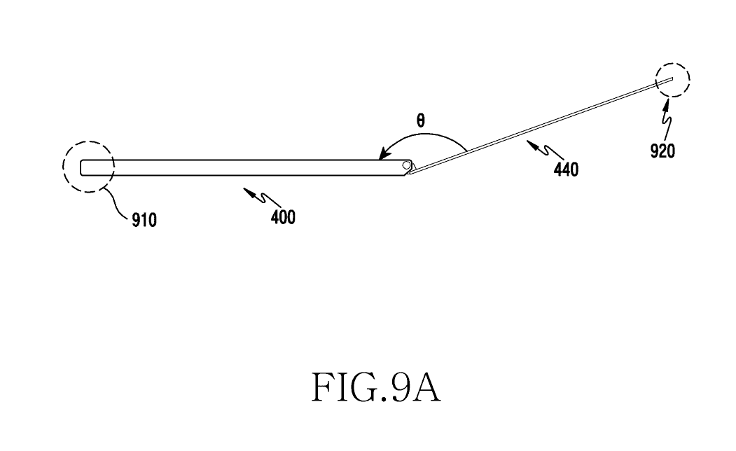

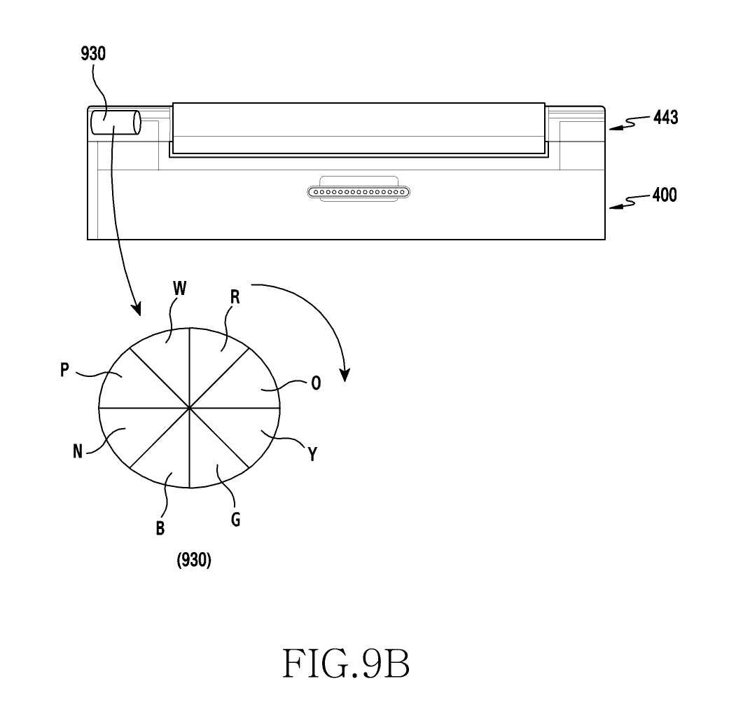

In addition, when the predetermined level is a value unit, a set value may increase as the change in the motion increases or may be set to decrease as the change in the motion increases. The processor 120 may detect the change in the motion until the change in the motion reaches the set value. The predetermined level may vary according to the fastening structure of the object connector, the settings of the electronic device 101, or user's settings. The predetermined level will be described in detail below with reference to FIGS. 8A to 8D and FIGS. 9A to 9C.

In step 505, the processor 120 displays a user interface related to the object according to the motion. The processor 120 may display the user interface corresponding to the motion of the object connector 410 differently, such that the user may intuitively know that the object connector 410 is being moved while the object connector 410 is secured to the electronic device 101. The user interface may display a character image related to the object. For example, when the processor 120 displays the character image while the object connector 410 is being inserted into the electronic device 101, the processor 120 may display only as many as areas corresponding to the motion. For example, the processor 120 may divide a single character image into three areas, and may display the areas one by one in sequence according to a change in the motion of the object connector 410 which is being inserted into the electronic device 101. In addition, it may be determined which area of the character image will be displayed first according to the motion, according to the settings of the electronic device 101, a user's setting, or the type of the object. In addition, the image of the character is divided into three areas, but is not limited to such and the number of areas the image of the character is divided into may be set variously, and for example, the image of the character may be divided into four or five areas.

In FIG. 5, the display of the user interface corresponding to the motion of the object connector 410 shown in FIG. 4A is described. However, regarding the cases of FIGS. 4B to 4E, the display of the user interface may be processed in the same or similar way. An example of displaying a user interface in a different way according to a fastening structure will be described in detail with reference to the drawings described below.

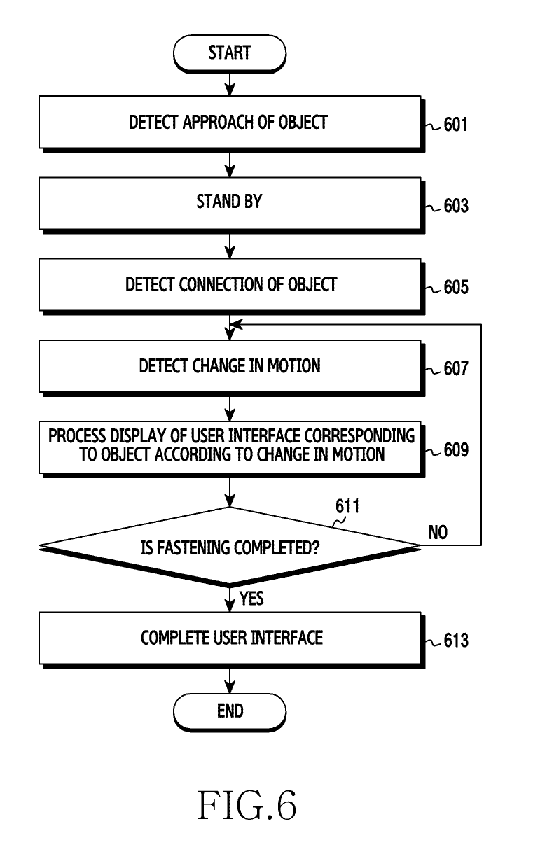

FIG. 6 illustrates a flowchart of a method for controlling a user interface according to a change in a motion according to an embodiment of the present disclosure.

Referring to FIG. 6, in step 601, the processor 120 detects an object approaching. The processor 120 may detect an object which is located within a designated distance using an RFID module. For example, when the RFID module is used, the processor 120 may detect an object located within the designated distance in real time or periodically.

In step 603, when the approach of the object is detected, the processor 120 stands by. According to an embodiment of the present disclosure, the standing by may refer to preloading a content related to the object. For example, when the approach of the object is detected, the processor 120 may automatically download data (for example, an application) regarding a content related to the object from an external device (for example, a server and the like). The object may include tag information, and, when the object approaches, the processor 120 may receive the tag information from the object.

The tag information may include at least one of a card unique identification number (ID), a service (or an item) provided by the object, the type (attribute) of a service, and information on a manufacturer and the like. The tag information may include at least one piece of information regarding an expiration date, a name, an explanation, a price, a uniform resource locator (URL), and a uniform resource name (URN) of data (or a content). However, the information including the tag information is not limited. Accordingly, the processor 120 may download the content related to the object in advance using the tag information, and may stand by. For example, the content may include at least one of a text, an image, a video, an icon, a symbol background screen, a home screen, or an application.

In step 605, the processor 120 detects that the object is connected. When the object is mounted in the hole 413 provided in the object connector 410, the processor 120 may detect that the object is connected (or mounted) using the sensor provided in the hole 413. For reference, the approach of the object may refer to a state in which the object is not still mounted in the hole 413 provided in the object connector 410, and the connection of the object may refer to a state in which the object is mounted in the hole 413 provided in the object connector 410.

According to an embodiment of the present disclosure, when the connection of the object is detected, the processor 120 may preload the content related to the object. For example, when the approach of the object is detected, the processor 120 may be in a standby state to preload, and, when the connection of the object is detected, the processor 120 may preload the content. That is, the processor 120 may receive the tag information from the object, identify an external device to load the content related to the object, set a channel (for example, a data communication channel) to receive the content from the external device, and stand by until the object is connected. When the object is connected, the processor 120 may load data regarding the content from the external device through the set channel. Alternatively, as described above, when the approach of the object is detected, the processor 120 may load the data regarding the content. In addition, when the object is connected, the processor 120 may start monitoring the motion of the object connector 410 connected with the object.

In step 607, the processor 120 detects a motion change value of the object connector 410 connected with the object. The motion change value may be a distance or value based on which the motion of the object connector 410 is detected. The processor 120 may determine whether the detected motion change value corresponds to a predetermined level. Accordingly, the motion change value may correspond to the predetermined level. The motion change value (or the predetermined value) may be determined according to how the object connector is fastened to the electronic device 101.

For example, when the object connector 410 is formed in an insertion type fastening structure as shown in FIG. 4A, the motion change value may be determined according to an insertion distance. Alternatively, when the object connector 420 is formed in a slide type fastening structure as show in FIG. 4B, the motion change value may be determined according to a slide distance. For example, the insertion distance may be a distance by which the object connector 410 may be inserted through the side surface of the lower end of the electronic device 101, and the slide distance is a distance by which the object connector 420 may slide to be fastened to the front surface or back surface of the electronic device 101. Therefore, the slide distance may be longer than the insertion distance. In this case, the predetermined level regarding the motion change value may be changed. Alternatively, when the object connector 440 is formed in a folding type fastening structure as shown in FIG. 4D or 4E, the motion change value may be determined according to a folding angle.

The object connector 410 which is formed in the insertion type fastening structure will be described by way of an example. When the insertion distance of the object connector 410 is set to 3 cm, the predetermined level may be determined to be a 1 cm unit. That is, the processor 120 may divide the predetermined level regarding the insertion distance into three levels, and, when the object connector 410 is moved by 1 cm, the processor 120 may determine that the motion change value reaches a first predetermined level (for example, a first level). When the motion of the object connector 410 is detected, but the detected motion change value is less than the predetermined level (for example, 1 cm), the processor 120 may stand by until the motion change value of the object connector 410 reaches the predetermined value. That is, the processor 120 may not change the user interface until the motion change value reaches the predetermined level.

In step 609, the processor 120 processes the display of the user interface corresponding to the motion change value. The user interface is related to the object, and for example, may be displaying a character image. The processor 120 may display the character image only as much as the predetermined level. For example, when the detected motion change value corresponds to the first level (for example, 1 cm), the processor 120 may display a user interface corresponding to the first level. In addition, when the detected motion change value corresponds to a second level (for example, 2 cm), the processor 120 may display a user interface corresponding to the second level. In addition, when the detected motion change value corresponds to a third level (for example, 3 cm), the processor 120 may display a user interface corresponding to the third level.

The motion change value may be detected as corresponding to the first level to the third level in sequence. That is, when the object is connected to the object connector 410 and then the processor 120 starts detecting the motion change value of the object connector 410, the first motion change value may correspond to the first level. Accordingly, when step 607 and step 609 are performed once, the user interface corresponding to the first level may be displayed. Next, after the user interface corresponding to the first level is displayed, step 611 is performed to determine whether the object connector 410 is completely fastened.

In step 611, the processor 120 determines whether the object connector 410 is completely fastened to the electronic device 101. While the object connector 410 is being fastened to the electronic device 101, the processor 120 may display the user interface related to the object according to the motion of the object connector 410. Accordingly, when the object connector 410 is completely fastened to the electronic device 101 (for example, view (a) of FIG. 4A), the processor 120 may not process the user interface corresponding to the motion of the object connector 410 and thus may perform step 613. However, when the object connector 410 is not completely fastened to the electronic device 101 (for example, view (b) of FIG. 4A), the processor returns to step 607.

When the object connector 410 is not completely fastened, the processor 120 performs step 607 to detect a motion change value. That is, after the user interface corresponding to the first level is displayed, the processor 120 may detect a second motion change value. The second motion change value may correspond to the second level. When the motion change value is detected, the processor 120 performs step 609 to display the user interface corresponding to the second level. After displaying the user interface corresponding to the second level, the processor 120 performs step 611 to determine whether the object connector 410 is completely fastened. When the object connector 410 is not completely fastened to the electronic device 101, the processor 120 returns to step 607.

The processor 120 performs step 607 to detect a motion change value. That is, after displaying the user interface corresponding to the second level, the processor 120 may detect a third motion change value. The third motion change value may correspond to the third level. When the motion change value is detected, the processor 120 performs step 609 to display the user interface corresponding to the third level. After displaying the user interface corresponding to the third level, the processor 120 performs step 611 to determine whether the object connector 410 is completely fastened.

When the object connector 410 is completely fastened, the processor 120 completes the user interface. Completing the user interface may be maintaining the user interface corresponding to the third level. Alternatively, completing the user interface may be displaying a corresponding screen (for example, a completion screen) on a user interface different from that of the third level.

According to an embodiment of the present disclosure, the processor 120 may divide a single character image into three areas, and may set the three areas to correspond to the three levels, respectively. For example, the first area of the character image may be displayed as the user interface in response to the first level, the second area of the character image may be displayed as the user interface in response to the second level, and the third area of the character image may be displayed as the user interface in response to the third level. Accordingly, when the detected motion change value corresponds to the first level (for example, 1 cm), the processor 120 may display the first area (for example, ⅓ of the area) of the character image as the user interface. When the detected motion change value corresponds to the second level (for example, 2 cm), the processor 120 may display the second area (for example, ⅔ of the area) of the character image as the user interface. When the detected motion change value corresponds to the third level (for example, 3 cm), the processor 120 may display the third area (for example, 3/3 of the area) of the character image as the user interface. Accordingly, the character image when the motion change value corresponds to the third level may be the entire area of the character image. It may be determined which area of the character image will be displayed according to the motion change value, according to the settings of the electronic device 101, a user's settings, or the type of the object.

In FIG. 6, the number of levels corresponding to the motion change value is set to three by way of an example. However, the number of levels is not limited and may be set to various numbers higher than one (for example, two, three, or four). A method of processing the user interface or an area for the user interface may vary according to the set number of levels.

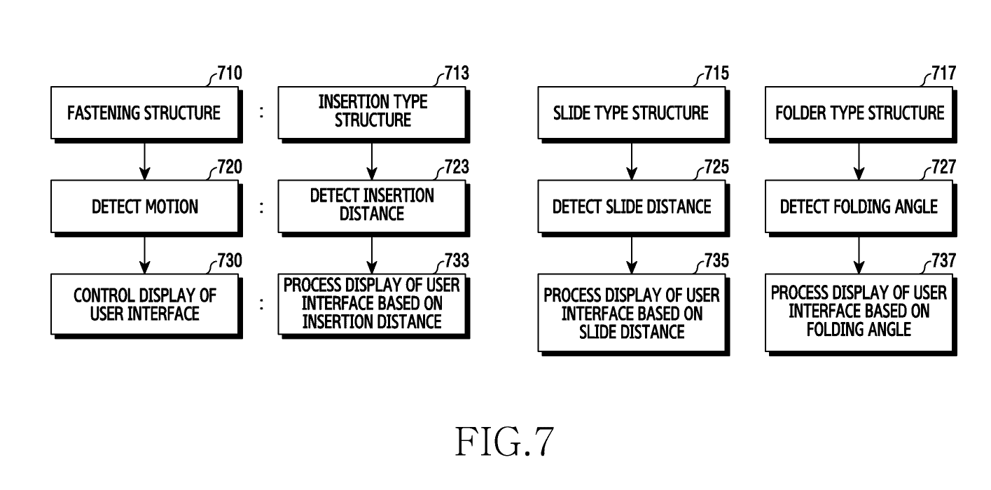

FIG. 7 illustrates flowcharts of methods for detecting a motion according to a fastening structure of an object connector according to an embodiment of the present disclosure.

Referring to FIG. 7, the electronic device 101 (for example, the processor 120) may have a different target object for detecting a motion according to a fastening structure 710 of the object connector. For example, the fastening structure 710 of the object connector may be classified into an insertion type structure 713 as shown in FIG. 4A, a slide type structure 715 as shown in FIG. 4B, and a folding type structure 717 as shown in FIG. 4D or 4E. The processor 120 may detect an insertion distance 723 as the target object for detecting the motion in the insertion type structure 713. The processor 120 may calculate the insertion distance in various ways. For example, the processor 120 may calculate the insertion distance by using a resistance value of a resistor disposed in a moving member (for example, a rail) for moving the object connector 410.

For example, the processor 120 may calculate a long insertion distance as the resistance value increases, and calculate a short insertion distance as the resistance value decreases. Alternatively, the reverse may be possible. Such a set value may vary according to the forming material of the object connector or a fastening structure. Alternatively, the processor 120 may calculate the insertion distance by measuring a rotation vector of the moving member of the object connector 410. For example, the moving member for moving the object connector 410 into the electronic device 101 may be formed of a toothed gear, and the processor 120 may calculate the insertion distance by calculating the number of turns of the toothed gear. The insertion distance may increase as the number of turns increases, and may decrease as the number of turns decreases. Alternatively, the reverse may be possible. Alternatively, the processor 120 may have a sensor (for example, a light sensor, a touch sensor, a physical switch, and the like) disposed opposite the end of the object connector 410, and may calculate the insertion distance of the object connector 410 by calculating a distance to the end of the object connector 410.

In addition, the processor 120 may detect a slide distance 725 as the target object for detecting the motion in the slide type structure 715. The processor 120 may calculate the slide distance in various ways. For example, when the object connector 420 slides into the electronic device 101 from the lower end of the electronic device 101 in the vertical direction, the processor 120 may include detection members formed at regular intervals in the vertical direction, for detecting whether the object connector 420 is fastened or slides. The processor 120 may calculate the slide distance based on a location which is detected through the detection member. When the object connector 420 is closed, the processor 120 may display an image related to the object on the display 160, and may change the home screen of the electronic device 101 to an icon related to the object. The processor 120 may actively display an image by adjusting the size of the image related to the object according to the slide distance.

In addition, the processor 120 may detect a folding angle 727 as the target object for detecting the motion in the folding type structure 717. The processor 120 may calculate the folding angle in various ways. For example, the processor 120 may calculate the folding angle by using a vector value which is measured by a sensor provided at the end of the object connector 440 facing the fastening member fastened to the side surface of the upper end of the electronic device 101, and a vector value which is measured by a sensor provided at the lower end of the electronic device. For example, the processor 120 may calculate the folding angle by calculating a difference between the vector values detected by the two sensors. As the difference between the vector values increases, the folding angle may increase, and as the difference between the vector values decreases, the folding angle may decrease. Alternatively, the reverse may be possible. The processor 120 may actively display an image by adjusting the size of the image related to the object according to the folding angle.

When the motion 720 is detected, the processor 120 displays a user interface 730 corresponding to the motion 720. For example, in the electronic device 101 of the insertion type structure 713, the processor 120 may control to display a user interface based on the insertion distance 733. Alternatively, in the electronic device 101 of the slide type structure 715, the processor 120 may control to display a user interface based on the slide distance 735. Alternatively, in the electronic device 101 of the folding type structure 717, the processor 120 may control to display a user interface based on the folding angle 737.

FIGS. 8A to 8D illustrate views of detecting a motion in the electronic device of the insertion type fastening structure according to an embodiment of the present disclosure.

FIG. 8A illustrates a view showing the structure of the electronic device which measures an insertion distance using a resistance value. Referring to FIG. 8A, a base moving member 810 of the electronic device 400, for moving the object connector 410 into the electronic device 400, and a moving member 417 of the object connector 410 may be formed of conductive material. When the object connector 410 is moved, friction occurs between the base moving member 810 and the moving member 417 and a resistance value may be measured. A detection member 817 may measure a resistance value of an area 815 where friction occurs between the base moving member 810 and the moving member 417, and forward the resistance value to the processor 120. Calculating the insertion distance according to the resistance value measured by the detection member 817 may be pre-set. For example, the insertion distance may be set to increase as the resistance value increases and to decrease as the resistance value decreases. Alternatively, the insertion distance may be set to increase as the resistance value decreases, and to decrease as the resistance value increases. Calculating the insertion distance according to the resistance value may vary according to the material of the object connector or a fastening structure.

FIG. 8B illustrates the structure of the electronic device which measures the insertion distance using a light sensor. Referring to view (a) of FIG. 8B, the electronic device 400 may calculate the insertion distance based on a sensor signal which is measured by a sensor 820 disposed opposite an end 415a of the object connector 410. Alternatively, referring to view (b) of FIG. 8B, the electronic device 400 may calculate the insertion distance based on a sensor signal which is measured by a sensor 820 disposed opposite an end 415b of the object connector 410. For example, the sensor 820, which may be a light sensor, may calculate the insertion distance by outputting a light emission signal and using a light reception signal corresponding to the light emission signal reflected from the end 415a of the object connector 410. The sensor 820 may calculate the insertion distance by using the time required to receive the light reception signal after the light emission signal has been output. The processor 120 may determine that, as the time required to receive the light reception signal is shorter, the insertion distance is longer. For example, when the time required to receive the light reception signal is short, a distance between the object connector 410 and the light sensor 820 is short, such that it may be determined that the object connector 410 is deeply inserted into the electronic device 400 and the insertion distance may be calculated as being long.

FIG. 8C illustrates the structure of the electronic device which measures the insertion distance by using a touch sensor. Referring to FIG. 8C, the touch sensor 830 may be disposed at the end of the object connector 410 inserted into the electronic device 400. The touch sensor 830 may include one or more contact terminals and calculate the insertion distance by determining which of the contact terminals the object connector 410 is brought into contact with. In FIG. 8C, the touch sensor is illustrated, but the touch sensor may have various forms such as a contact sensor, a physical switch, and the like to determine whether the object connector 410 is in contact.

For example, the touch sensor 830 may include at least five contact terminals, and the contact terminals may be arranged in sequence from the lower end to the upper end of the electronic device 400 in the vertical direction. For example, the first contact terminal may be disposed at the lower end and the second contact terminal to the fifth contact terminal may be arranged in sequence in an upward direction. Accordingly, when the object connector 410 is brought into contact with the first contact terminal, the processor 120 may determine that the object connector 410 is moved by a first insertion distance, and, when the object connector 410 is brought into contact with the second contact terminal, the processor 120 may determine that the object connector 410 is moved by a second insertion distance. When the end of the object connector 410 is brought into contact with the fifth contact terminal, the processor 120 may determine that the object connector 410 is completely fastened to the electronic device 400.

FIG. 8D illustrates a view illustrating the structure of an electronic device which measures the insertion distance using a rotation vector value. Referring to view (a) of FIG. 8D, the moving member of the object connector 410 may be formed as a toothed gear, and when the object connector 410 is moved, the toothed gear may be rotated. When the toothed gear is rotated, the processor 120 may measure a rotation vector according to the rotation of the toothed gear. The processor 120 may measure the insertion distance by calculating the number of turns of the toothed gear. As the number of turns increases, the insertion distance may increase, and, as the number of turns decreases, the insertion distance may decrease. The toothed gear may be formed in a star shape having five protrusions as shown in view (b) of FIG. 8D. Alternatively, the toothed gear may be formed in a polygonal shape including eight protrusions as shown in view (c) of FIG. 8D, or may be formed in a polygonal shape including 16 protrusions as shown in view (d) of FIG. 8D. The processor 120 may calculate the rotation vector, the rotation angle, and the number of turns based on the number of protrusions of the toothed gear.

FIGS. 9A to 9C illustrate views of detecting a motion in the electronic device of the folding type fastening structure according to an embodiment of the present disclosure.

FIG. 9A illustrates a view of detecting a motion using an earth magnetic field sensor. Referring to FIG. 9A, the object connector 440 may include an earth magnetic field sensor formed at an end 920 of the object connector 440 opposite to the fastening member fastened to the side surface of the upper end of the electronic device 400. In addition, the electronic device 400 may include an earth magnetic field sensor formed on the side surface 910 of the lower end opposite to the fastening member of the object connector 400. A folding angle (θ) may be calculated based on a difference between the vector values measured by the two earth magnetic field sensors. For example, when the object connector 440 is connected to the fastening member, the processor 120 may receive the vector value measured by the earth magnetic field sensor of the object connector 440. The processor 120 may calculate the folding angle by calculating a difference value between the vector value received thereby and the vector value measured by the earth magnetic field sensor thereof. As the difference between the vector values increases, the folding angle may increase, and as the difference between the vector values decreases, the folding angle may decrease. Alternatively, as the difference between the vector values increases, the folding angle may decrease, and, as the difference between the vector values decreases, the folding angle may increase.

FIG. 9B illustrates a view of detecting a motion using a light sensor disposed on the fastening member. Referring to FIG. 9B, the object connector 440 may include a light sensor 930 disposed on the fastening member fastened to the side surface of the upper end of the electronic device 400. The light sensor 930 may be formed in a cylindrical shape, and the circle of the side surface of the cylinder may be divided into areas of different colors, or may be formed of surfaces treated differently. In this case, when the fastening member is rotated, a light reception signal is received in response to a light emission signal output from the light sensor 930. In this case, a different reflection value (for example, different time required to receive the light reception signal) is measured according to each of the areas, and the processor 120 may calculate the folding angle using the reflection values.

For example, as shown in view (b) of FIG. 9B, the circle is divided into eight areas and the areas are distinguished from one another by color. For example, the first area (R) may be designated by red color, the second area (O) may be designated by orange color, the third area (Y) may be designated by yellow color, the fourth area (G) may be designated by green color, the fifth area (B) may be designated by blue color, the sixth area (N) may be designated by navy color, the seventh color (P) may be designated by purple color, and the eighth area (W) may be designated by white color. Alternatively, the areas may be distinguished by treating the surfaces differently, for example, by treating the first area (R) convexly and treating the second area (O) concavely.

FIG. 9C illustrates a view of detecting a motion using a toothed gear disposed on the fastening member. Referring to FIG. 9C, the object connector 440 may include a toothed gear 940 formed on the fastening member fastened to the side surface of the upper end of the electronic device 400. The toothed gear 940 may be rotated as the fastening member is rotated. When the toothed gear 940 is rotated, the processor 120 may measure a rotation vector according to the rotation of the toothed gear 940. The processor 120 may calculate the folding angle (θ) by calculating the number of turns of the toothed gear 940. As the number of turns increases, the folding angle increases, and as the number of turns decreases, the folding angle decreases. The toothed gear may be formed in a polygonal shape having eight protrusions as shown in view (c) of FIG. 8D. Alternatively, the toothed gear may be formed in a star shape having five protrusions as shown in view (b) of FIG. 8D, or may be formed in a shape having 16 protrusions as shown in view (d) of FIG. 8D. The processor 120 may calculate the rotation vector, the rotation angle, or the number of turns based on the number of protrusions of the toothed gear.

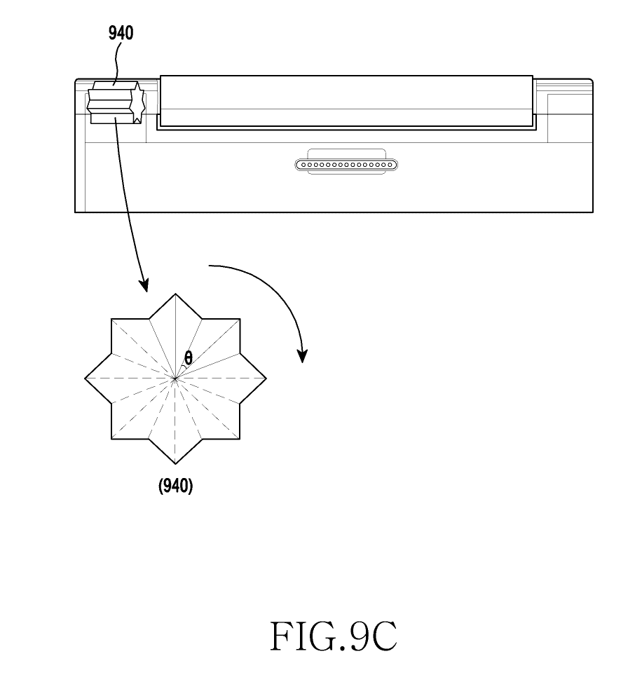

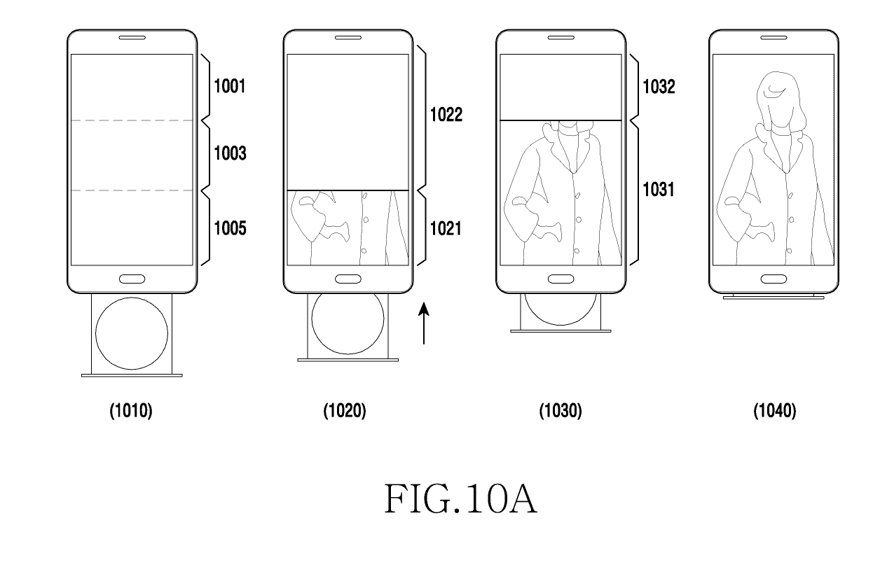

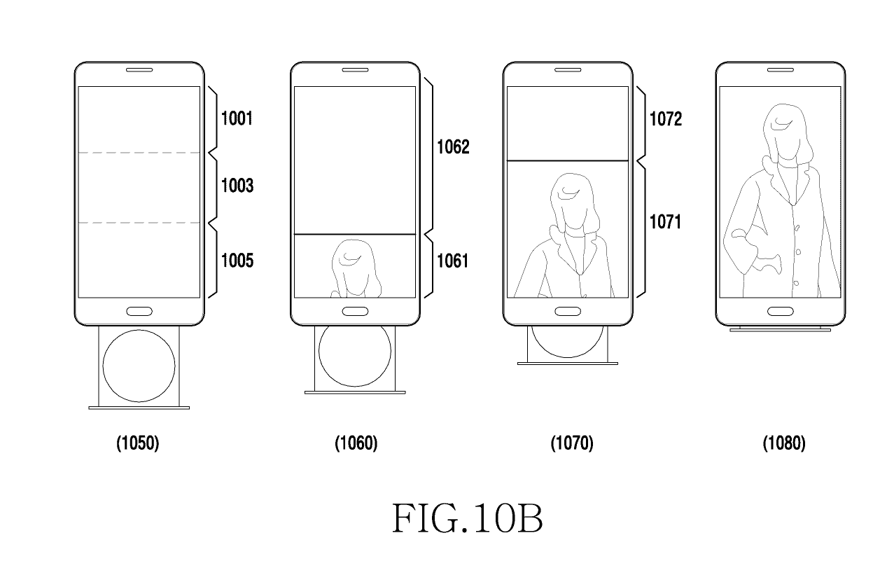

FIGS. 10A and 10B illustrate views of displaying a user interface in the electronic device of the insertion type fastening structure according to an embodiment of the present disclosure. For reference, FIGS. 10A and 10B illustrate views showing an example of processing a user interface (for example, a woman's upper body image) when a first object is connected to the object connector 410.

FIG. 10A illustrates a view showing an example of changing a display area according to an insertion distance. Referring to view 1010 of FIG. 10A, the processor 120 may divide a display area of the electronic device 101 into three areas. That is, the display area of the electronic device 101 may be divided into a first display area 1001, a second display area 1003, and a third display area 1005. The sum of the three divided areas may correspond to the display area of the electronic device 101. As the display area is divided into the three areas, the processor 120 may divide the level corresponding to a change in the motion detected according to the insertion distance into three levels.

For example, when the detected change in the motion corresponds to a first level, the processor 120 may process a user interface corresponding to the first level, when the detected change in the motion corresponds to a second level, the processor 120 may process a user interface corresponding to the second level, and, when the detected change in the motion corresponds to a third level, the processor 120 may process a user interface corresponding to the third level. In this case, the processor 120 may determine the display areas corresponding to the first level to the third level.

Referring to view 1020, the processor 120 may not activate the first display area 1001 and the second display area 1003, and may activate the third display area 1005 according to the motion of the object connector 410. That is, the processor 120 may not use the first display area 1001 and the second display area 1003, and may display a user interface related to the object by using only the third display area 1005. For example, the user interface related to the object may display a woman's upper body image as shown in view 1040. However, the processor 120 may not display the user interfaces corresponding to the first display area 1001 and the second display area 1003, and may display only the user interface corresponding to the third display area 1005 according to the motion of the object connector 410. For example, when the motion change value of the object connector 410 corresponds to the first level (for example, an insertion distance of 1 cm), the processor 120 may display an image related to the object only on the third display area 1005 as the user interface corresponding to the first level. That is, as shown in view 1020, the processor 102 may display only the chest part of the woman's upper body image on the display area.

Referring to view 1030, the processor 120 may not activate the first display area 1001 and may activate the second display area 1003 and the third display area 1005 according to the motion of the object connector 410. In this case, as shown in view 1030, a character image displaying from the chin to the chest of the woman's upper body image may be displayed on the display area. For example, when the motion change value of the object connector 410 corresponds to the second level (for example, an insertion distance of 2 cm), the processor 120 may display the image related to the object only on the second display area 1003 and the third display area 1005 as the user interface corresponding to the second level.

Referring to view 1040, the processor 120 may activate the first display area 1001 to the third display area 1005 according to the motion of the object connector 410. In this case, as shown in view 1040, the entirety of the woman's upper body image may be displayed on the display area. For example, when the motion change value of the object connector 410 corresponds to the third level (for example, an insertion distance of 3 cm), the processor 120 may display the woman's upper body image related to the object only on the first display area 1001 to the third display area 1005 as the user interface corresponding to the third level.

FIG. 10B illustrates a view of displaying an area of a displayed character image according to an insertion distance. Referring to view 1050 of FIG. 10B, the processor 120 may divide an area of an image 1080 related to an object into three areas as a user interface. That is, the processor 120 may divide the area of the single image 1080 into the first area 1001, the second area 1003, and the third area 1005. The sum of the three divided areas may complete the single image 1080. As the area of the character image is divided into three areas, the processor 120 may divide the level corresponding to the change in the motion detected according to the insertion distance into three levels.

Referring to view 1060, when the motion change value of the object connector 410 corresponds to the first level (for example, the insertion distance of 1 cm), the processor 120 may display the first area 1001 of the single image 1080 as the user interface corresponding to the first level. That is, the processor 120 may display only the head part of the image 1080 on the display area as shown in view 1060. For example, the object connector 410 may be inserted upwardly when the electronic device 101 is placed in the vertical direction. In this case, the processor 120 may display only the first area of the image 1080 to correspond to the insertion direction of the object connector 410. In addition, unlike in FIG. 10A, the processor 120 may change the area of the displayed image, rather than activating a part of the display area or not activating. That is, in view 1020, only the third display area 1005 may be activated, whereas, in view 1060, all of the display areas (for example, the first display area 1001 to the third display area 1005) of the electronic device 101 may be activated. That is, in view 1060, a visual effect as if the image is moved according to the motion of the object connector 410 may be provided.

Referring to view 1070, when the motion change value of the object connector 410 corresponds to the second level (for example, the insertion distance of 2 cm), the processor 120 may display the second area 1003 of the single image 1080 as the user interface corresponding to the second level. That is, the processor 120 may display only the head part and the neck part of the image 1080 on the display area as shown in view 1070.

Referring to view 1080, when the motion change value of the object connector 410 corresponds to the third level (for example, the insertion distance of 3 cm), the processor 120 may display the entire single image 1080 (for example, the first area 1001 to the third area 1005) as the user interface corresponding to the third level. That is, the processor 120 may display the entire area of the image as shown in view 1080.

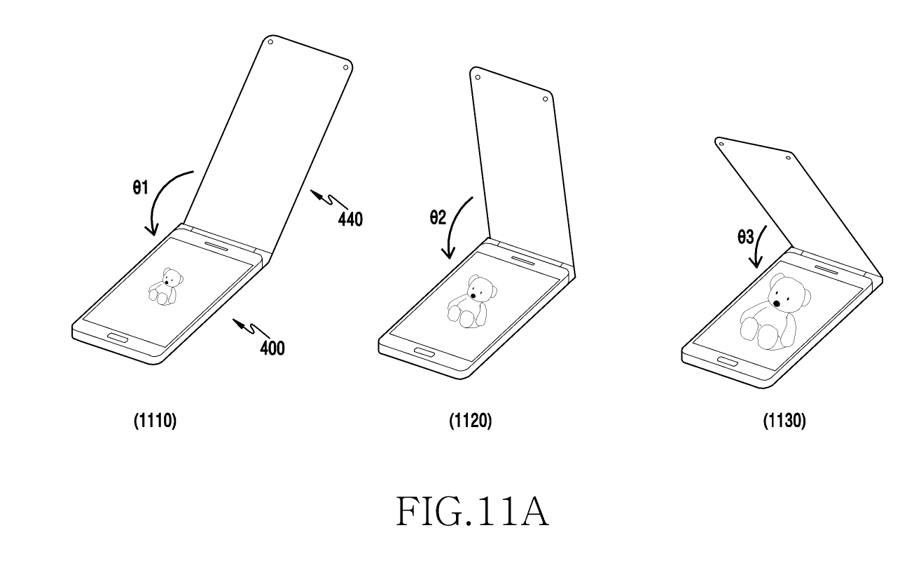

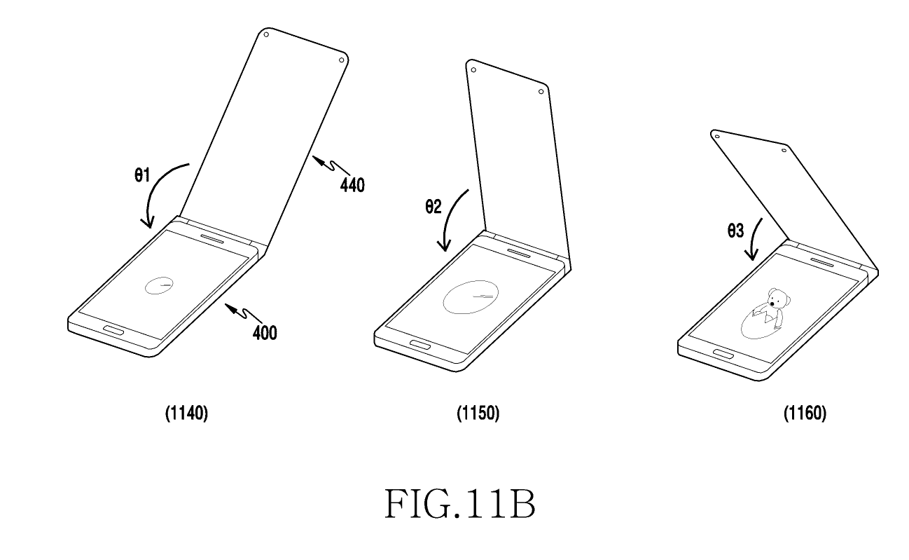

FIGS. 11A and 11B are views illustrating displaying a user interface in the electronic device of the folding type fastening structure according to an embodiment of the present disclosure.

FIG. 11A illustrates a view of displaying a displayed image according to a folding angle. For reference, FIGS. 11A and 11B illustrate views showing examples of processing a user interface when an object related to a teddy bear is connected to the object connector 440.

Referring to FIG. 11A, the processor 120 may divide the rotation of the folding type fastening structure into three levels according to a folding angle with the object connector 440, and may divide the size of the teddy bear image related to the object to correspond to the three levels. For example, the first level may indicate that the folding angle is 150°, the second level may indicate that the folding angle is 120°, and the third level may indicate that the folding angle is 90°. The corresponding sizes of the teddy bear image may be a small size, a medium size, and a large size.

Referring to view 1110, when the folding angle with the object connector 440 is the first level (θ1), the processor 120 may display the teddy bear image of the small size corresponding to the first level as the user interface. Referring to view 1120, when the folding angle with the object connector 440 is the second level (θ2), the processor 120 may display the teddy bear image of the medium size corresponding to the second level as the user interface. In addition, referring to view 1130, when the folding angle with the object connector 440 is the third level (θ3), the processor 120 may display the teddy bear image of the large size corresponding to the third level as the user interface.

Accordingly, in FIG. 11A, the electronic device 101 may provide a visual effect as if the teddy bear image is magnified according to the motion of the object connector 440.

FIG. 11B illustrates a view of displaying a displayed image according to a folding angle. Referring to FIG. 11B, the processor 120 may divide the rotation of the folding type fastening structure into three levels according to a folding angle with the object connector 440, and may divide the type of an image related to a character to correspond to the three levels. For example, the first level may indicate that the folding angle is 150°, the second level may indicate that the folding angle is 120°, and the third level may indicate that the folding angle is 90°. The corresponding types of the images may be a first type (for example, a small egg image), a second type (for example, a large egg image), and a third type (for example, a hatched egg).

Referring to view 1140, when the folding angle with the object connector 440 is the first level (θ1), the processor 120 may display the small egg image corresponding to the first level as the user interface. Referring to view 1150, when the folding angle with the object connector 440 is the second level (θ2), the processor 120 may display the large egg image corresponding to the second level as the user interface. In addition, referring to view 1160, when the folding angle with the object connector 440 is the third level (θ3), the processor 120 may display the hatched egg image corresponding to the third level as the user interface. The hatched egg image may be an image showing that a teddy bear hatches out from the egg. That is, the images displayed in views 1140 to 1160 are all related to a single object and are only different from one another in view of types. Alternatively, an image related to the object may be displayed in a manner in which the object is gradually magnified, the object bursts under the pressure as the folding angle increases, or the object inflates.

Accordingly, in FIG. 11B, the electronic device 101 may provide a visual effect as if the egg image is gradually enlarged according to the motion of the object connector 440 and the teddy bear hatches from the egg.

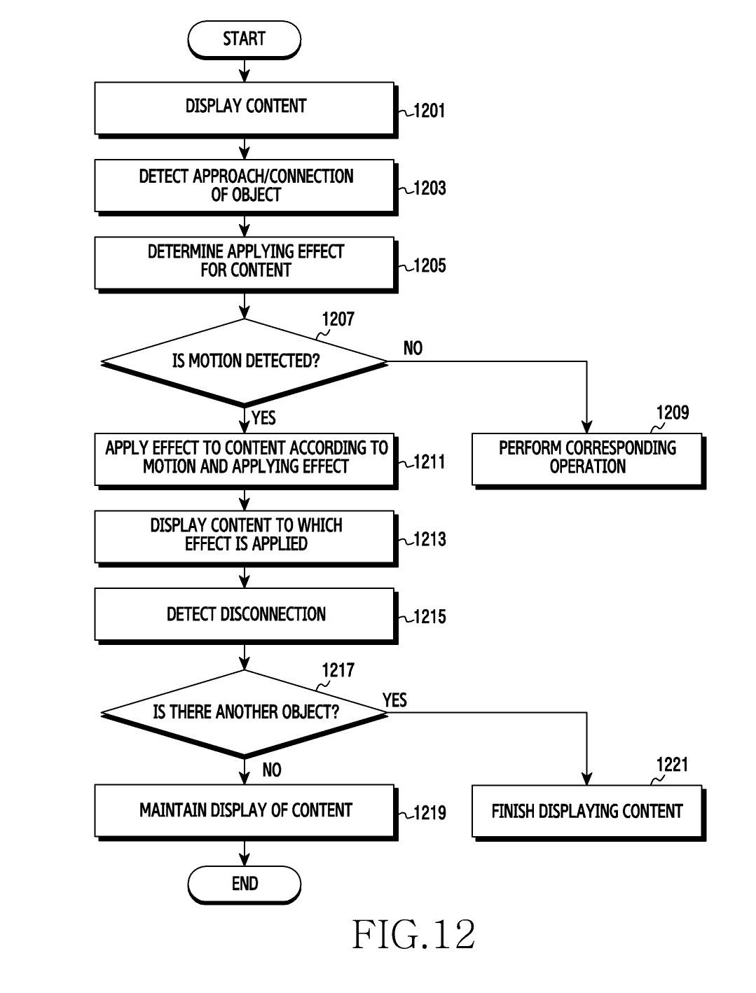

FIG. 12 illustrates a flowchart of an operation of processing a user interface in the electronic device according to an embodiment of the present disclosure.

Referring to FIG. 12, in step 1201, the electronic device 101 (for example, the processor 120) displays a content on the display 160. The content may include multimedia data such as a text, an image, a voice, a sound, a video, and the like. In addition, the content may include at least one of a background screen, a home screen, or an application. The processor 120 may display the content on the display 160 according to a user's request.

In step 1203, the processor 120 detects an approach or connection of an object. The detailed operation of detecting the approach or connection of the object has been described with reference to FIGS. 5 and 6, and thus a detailed description thereof is omitted here. The processor 120 may detect the approach or connection of the object in the same or similar way as the operation described in FIGS. 5 and 6. The processor 120 may detect the approach or connection of the object while displaying the content.

In step 1205, the processor 120 determines an applying effect for the displayed content. For example, the processor 120 may provide a visual effect regarding the displayed content according to the connection of the object. The visual effect may mean that a user interface is changed according to a change in the distance or speed. However, the visual effect may be applied differently according to the content or object. Accordingly, the processor 120 may identify what effect may be applied to the displayed content. For example, the effect may be changing color of a character image, changing the character image, or changing the location of the character according to the distance or speed. The processor 120 identifies the applying effect for the content in advance, such that, when the object connector 410 is moved, the processor 120 may immediately apply the effect to the content.

In step 1207, the processor 120 detects a motion of the object connector 410. The motion of the object connector 410 may indicate a change in the distance or speed. The processor 120 may detect the change in the speed by calculating a distance moved per hour. When the motion is detected, the processor 120 may determine a target object for detecting the motion based on the applying effect. For example, when the applying effect is based on the change in the speed, the processor 120 may detect the change in the speed. However, when the applying effect is based on the change in the distance, the processor 120 may detect the change in the distance. Alternatively, when the applying effect is based on the change in the distance and the change in the speed, the processor 120 may detect both the change in the distance and the change in the speed.

The processor 120 performs step 1211 when the motion of the object connector 410 is detected, or performs step 1209 when the motion of the object connector 410 is not detected.

When the motion of the object connector 410 is not detected, the processor 120 performs a corresponding operation in step 1209. For example, when the motion of the object connector 410 is not detected and a user input is received, the processor 120 may perform an operation according to the user input. For example, the operation according to the user input may be a normal operation of the electronic device 101 having nothing to do with the motion of the object connector 410.

When the motion of the object connector 410 is detected, the processor 120 applies an effect to the content according to the detected motion and the applying effect in step 1211. For example, the detected motion may be the change in the distance and the applying effect may be changing color. Alternatively, the detected motion may be the change in the speed and the applying effect may be changing the character image or changing the content.

In step 1213, the processor 120 displays the content to which the effect is applied. For example, the processor 120 may display the content to which a change in color is applied. Alternatively, the processor 120 may display by changing the character image or changing the content.

In step 1215, the processor 120 detects whether the object is disconnected from the object connector 410. The processor 120 may receive information indicating whether the object is connected or whether the object is disconnected from the sensor (or interface) included in the object connector 410.

When the disconnection is detected, the processor 120 determines whether another object approaches or is connected in step 1217. When the approach or connection of another object is detected, the processor 120 performs step 1221. When the approach or connection of another object is not detected, the processor 120 performs step 1219.

In step 1219, when the approach or connection of another object is not detected, the processor 120 maintains the display of the content. In this case, maintaining the display of the content may be maintaining the display of the content to which the effect is applied.

When the approach or connection of another object is detected, the processor 120 finishes displaying the content to which the effect is applied in step 1221. Alternatively, the processor 120 may determine an operation to perform according to the approach or connection of another object, according to the settings of the disconnected object, the settings of another object, or the settings of the electronic device 101. For example, the processor 120 may finish displaying the content or may maintain the display of the content to which the effect is not applied.

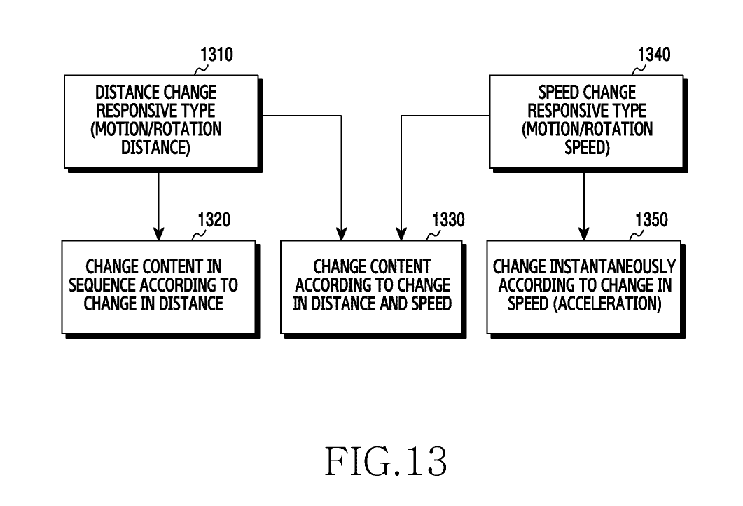

FIG. 13 illustrates a view of an operation of determining a target object for detecting a motion according to a content in the electronic device according to an embodiment of the present disclosure.

Referring to FIG. 13, when the motion of the object connector 410 is detected, the processor 120 may determine a target object for detecting the motion according to a content. For example, when the type of a content or an effect to be applied to the content is a distance change responsive type 1310, the processor 120 may detect a change in the distance as the motion of the object connector 410. The distance change responsive type may mean that the applying effect varies according to a moving distance or a rotation distance. In this case, the processor 120 may change the content in sequence according to the change in the distance 1320. Alternatively, when the type of a content or an effect to be applied to the content is a speed change responsive type 1340, the processor 120 may detect a change in the speed as the motion of the object connector 410. The speed change responsive type may mean that the applying effect varies according to a moving speed or a rotation speed. In this case, the processor 120 may change the content instantaneously according to the change in the speed 1350. Alternatively, the processor 120 may change the content by applying both the change in the distance and the change in the speed 1330.

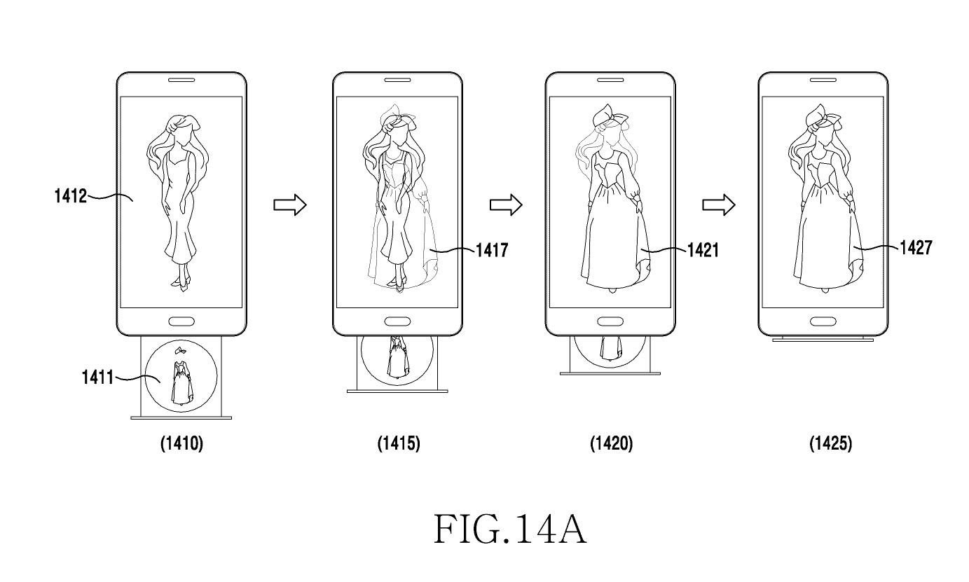

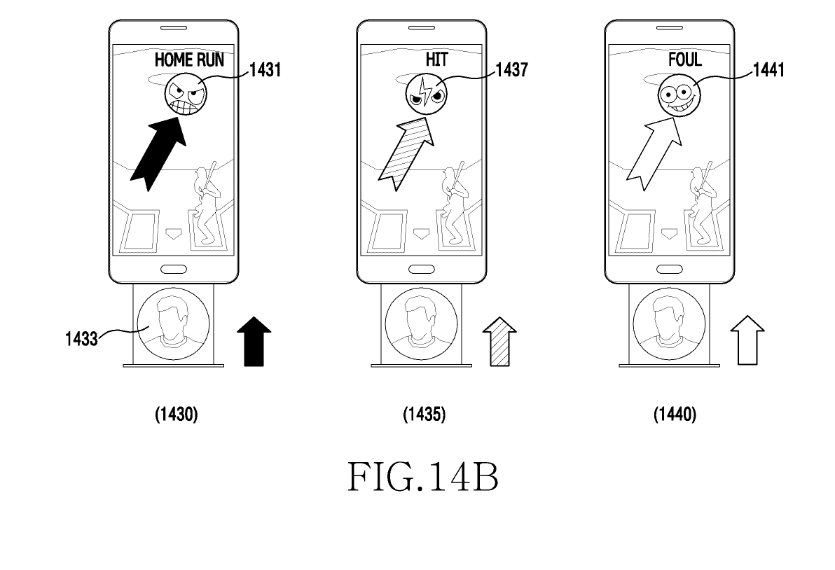

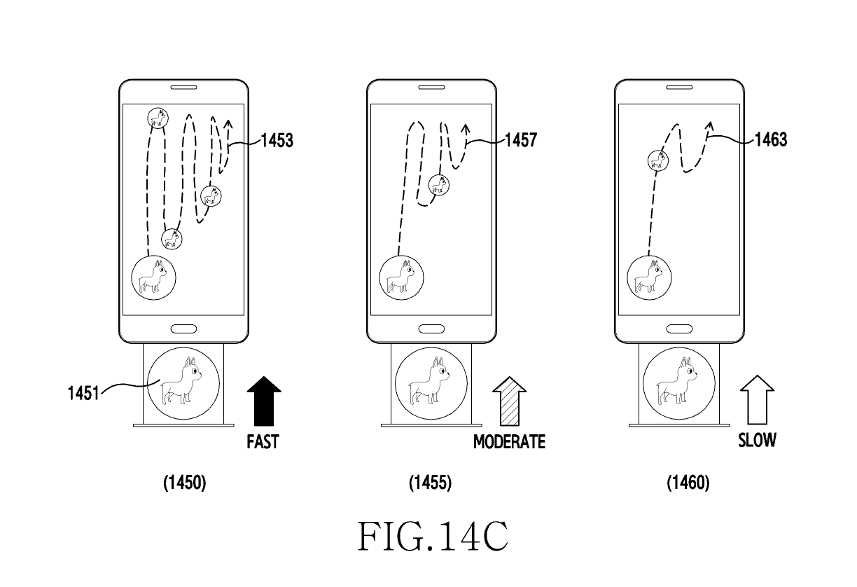

FIGS. 14A to 14C illustrate views of applying an effect related to an object to a content in the electronic device according to an embodiment of the present disclosure.

FIG. 14A illustrates a view of applying a change in color to a content as an effect related to an object. Referring to view 1410 of FIG. 14A, the processor 120 may detect an approach or connection of an object 1411 while displaying a content 1412 on the display 160. The content 1412 may be a character image and the object 1411 may give an effect of putting clothes on the character image. The processor 120 may determine an applying effect for the content 1412. For example, the applying effect may be adding (superimposing) or changing a clothes image on the character image according to a change in the distance. Referring to view 1415, the processor 120 may superimpose an image 1417 of the object on the content displayed on the display 160. In this case, the processor 120 may adjust the light and darkness of the image 1417 of the object based the motion of the object connector 410 to which the object 1411 is connected.

For example, when a change in the motion of the object connector 410 corresponds to 1 (for example, a first level) as shown in view 1415, the processor 120 may control the display of the lightness and darkness of the image 1417. Alternatively, when a change in the motion of the object connector 410 corresponds to 2 (for example, a second level) as shown in view 1420, the processor 120 may display the lightness and darkness of an image 1421 more clearly (or more deeply) than the image 1417. Alternatively, when a change in the motion of the object connector 410 corresponds to 3 (for example, a third level) as shown in view 1425, the processor 120 may display the original lightness and darkness of an image 1427. The first level may mean that a moving distance is shorter than the second level. The third level may mean that there are few changes in the motion, that is, that the object connector 410 is completely fastened to the electronic device 101. Accordingly, comparing views 1410 to 1425 in sequence, it may be seen that the image of the clothes becomes clearer toward view 1425. That is, the processor 120 may give an effect as if the color of the clothes becomes darker according to the change in the motion of the object connector 410 and the clothes are put on the character.

FIG. 14B illustrates a view of adding an image to a content as an effect related to an object. Referring to FIG. 14B, the processor 120 may detect an approach or connection of an object 1433 while displaying a content on the display 160. Herein, the content may be a baseball content or a screen on a baseball application. The object 1433 may be giving an effect as if a batter hits a ball in a baseball game. The processor 120 may determine an applying effect for the content. For example, the applying effect may be a baseball flying or a new image being added according to a change in the speed. That is, the applying effect may be recognizing an inertia effect or an input of specific strength, and displaying a result.

Referring to view 1430, the processor 120 may display an image showing that a batter corresponding to the object 1433 hits a ball on the content based on the motion of the object connector 410 to which the object 1433 is connected. For example, in view 1430, a change in the speed is fast, and the processor 120 may display a character image 1431 showing that the batter hits the ball with speed and hits a home run on the content displayed on the display 160 based on the rapid change in the speed. In view 1435, the change in the speed corresponds to a moderate speed, and the processor 120 may display a character image 1437 showing that the batter hits the ball safely on the content displayed on the display 160 based on the moderate speed change. In view 1440, the change in the speed corresponds to slow speed, and the processor 120 may display a character image 1441 showing that the batter hits a ball on the content displayed on the display 160 based on the slow speed change.

Accordingly, in FIG. 14B, the electronic device 101 may give an effect as if the batter hits the ball by moving the object connector 420 band giving an interaction to the content according to the change in the speed of the object connector 410.

FIG. 14C illustrates a view of changing a location of an image as an effect related to an object. Referring to FIG. 14C, the processor 120 may detect an approach or connection of an object 1451. The object 1451 may be a teddy bear character. The processor 120 may determine an effect of changing the location of the teddy bear image according to a change in the speed of the object connector 410, based on the type of the object 1451. When a motion of the object connector 410 is detected, the processor 120 may detect a change in the speed.

View 1450 is an example of providing an effect according to a rapid speed change. For example, when the motion of the object connector 410 is a rapid speed change, the processor 120 may process an effect (for example, an inertia effect, an elasticity effect, and the like) showing that a teddy bear image 1453 jumps up like a spring according to the motion of the object connector 410. In view 1455, the change in the speed corresponds to a moderate speed, and when the motion of the object connector 410 is a moderate speed change, the processor 120 may process an effect showing that a teddy bear image 1457 jumps up according to the motion of the object connector 410. In view 1455, the effect may be different from the effect in view 1450. Since the change in the speed is the moderate speed in view 1455, the processor 120 may reduce the number of times that the teddy bear image 1457 jumps up or reduce the jump height of the teddy bear image 1457 in view 1455.

In view 1460, the change in the speed corresponds to slow speed, and the processor 120 may process an effect showing that a teddy bear image 1463 jumps up like a spring according to the motion of the object connector 410 based on the slow speed change. The processor 120 may process the effect in view 1460 and the effect in view 1455 differently. Since the change in the speed is the slow speed in view 1460, the processor 120 may reduce the number of times that the teddy bear image 1463 jumps up or may reduce the jump height of the teddy bear image 1463 in view 1460.

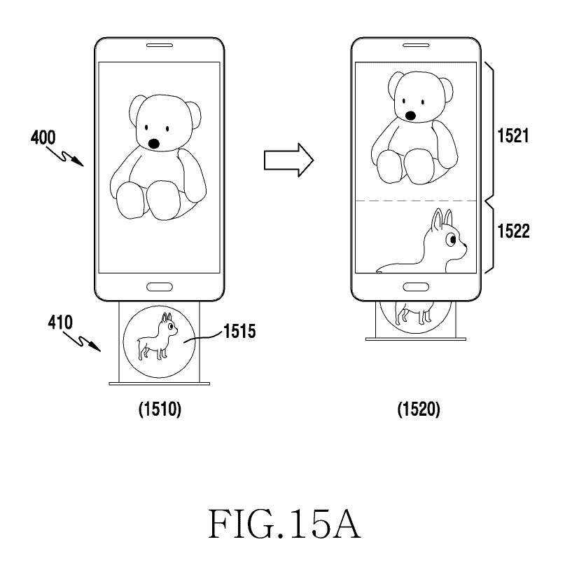

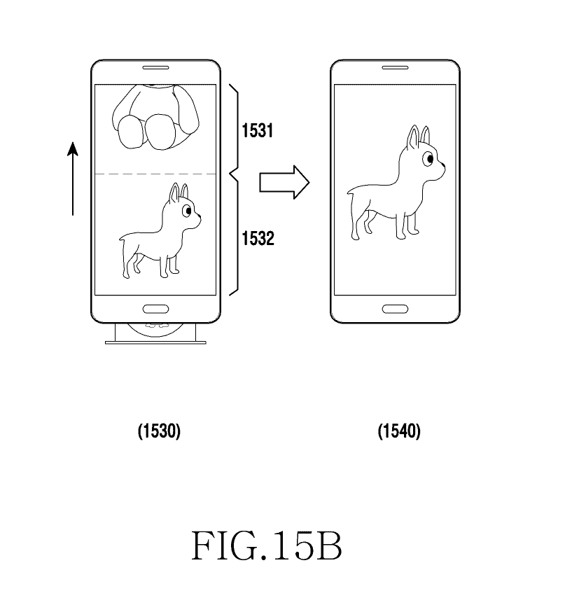

FIGS. 15A and 15B illustrate views of displaying a user interface according to a change in an object in the electronic device according to an embodiment of the present disclosure.

Referring to FIG. 15A, view 1510 illustrates a user interface when the connection of a first object is removed while a first image of the first object is being displayed, and a connection of a second object 1515 is detected. That is, the connection of the first object may be removed while the image (for example, a teddy bear image) of the first object is being displayed on the electronic device 400, and the connection of the second object 1515 may be detected. The second object 1515 may be displaying a puppy image. In this case, the processor 120 may maintain the image of the disconnected first object. According to an embodiment of the present disclosure, the processor 120 may determine an operation to perform according to the approach or connection of the second object according to the settings of the disconnected first object, the settings of the second object, and the settings of the electronic device 400.

When the connection of the second object 1515 is detected, the processor 120 may detect a motion of the object connector 410. When the motion is detected, the processor 120 may display a combination of the image of the first object and the image of the second object 1515 based on the motion. Referring to view 1520, the processor 120 may scroll up the image of the first object from the original position and display the image on a first display area 1521, and may display the image of the second image 1515 on a second display area 1522. A display ratio between the image of the first object and the image of the second object 1515 on the display area may be determined based on a coefficient according to insertion time or an insertion distance.

The processor 120 may determine a display ratio of the image of the first object and the image of the second object 1515 on the display area using Equation (1) below.

L2=L1/L3*f(t)*L4 (1)

where L1 is a longitudinal length of a display area, L2 is a total insertion distance of the object connector 410, L3 is a distance that an object will be inserted, and L4 is a distance that an object has been inserted. Accordingly, L1/L3 may refer to a ratio between the length of the object connector 410 and the display area. The longitudinal length of the display area may refer to a longer one of the vertical length and the horizontal length of the display area.

Referring to view 1530 of FIG. 15B, the processor 120 may display the image of the first object on a first display area 1531, and display the image of the second object 1515 on a second display area 1532 according to the motion of the object connector 410. Comparing views 1520 and 1530, as the object connector 410 is further moved into the electronic device 400, the first display area 1531 becomes smaller than the first display area 1521. On the other hand, the second display area 1532 becomes greater than the second display area 1522.

Referring to view 1540, when the object connector 410 is completely inserted into the electronic device 400, the processor 120 may display the character image of the second object 1515 on the entire display area.

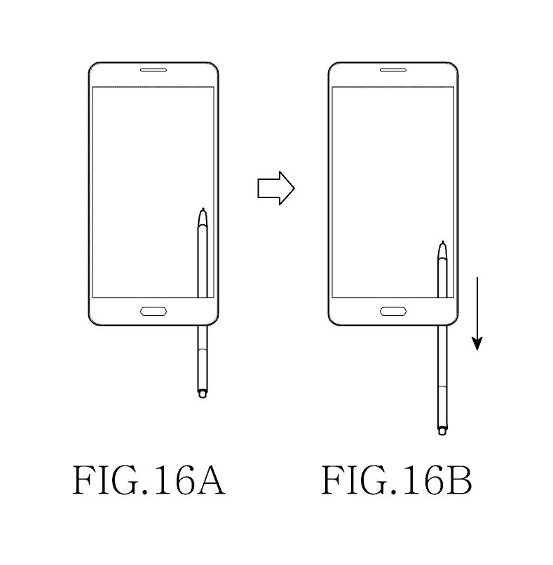

FIGS. 16A and 16B illustrate views of displaying a user interface according to a pen insertion in the electronic device according to an embodiment of the present disclosure.

Referring to FIGS. 16A and 16B, when a motion of drawing out a pen inserted into the electronic device is detected, the processor 120 may display the shape of the pen on the display according to the motion of the pen. For example, FIG. 16B illustrates a user interface screen which is displayed when the pen is drawn out from the electronic device by half, and FIG. 16A illustrates a user interface screen when the pen is drawn out from the electronic device by ⅓. In addition, although not shown, the processor 120 may provide various visual effects according to the motion of the pen when the pen is inserted into the electronic device.

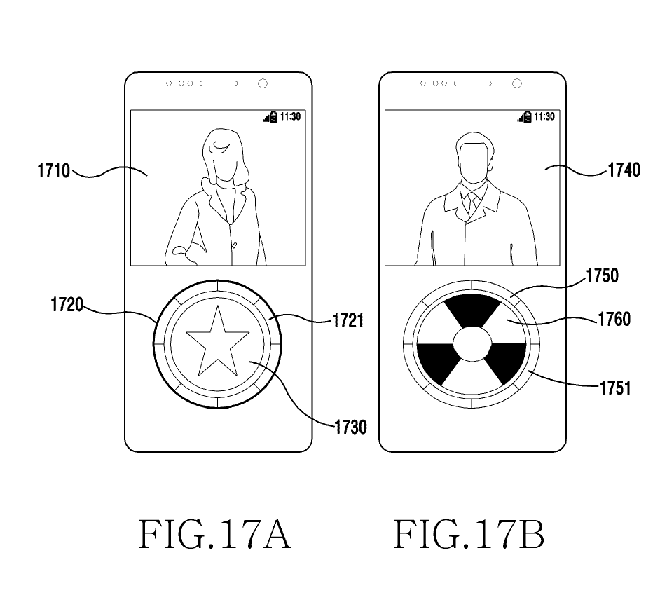

FIGS. 17A and 17B illustrate views of providing a visual effect using an LED in an electronic device of a fixed type fastening structure according to an embodiment of the present disclosure.

Referring to FIGS. 17A and 17B, when an object is inserted into the fixed type fastening structure, the processor 120 may emit light using an LED. As shown in FIG. 17A, the processor 120 may display an image (for example, a woman's upper body image) regarding a first object 1730 on a display 1710, and display a battery charging gauge 1721 of the electronic device on an LED member 1720. When a battery is charged, the processor 120 may display the battery charging gauge 1721. Alternatively, as shown in FIG. 17B, the processor 120 may display an image (for example, a man's upper body image) regarding a second object 1760 on a display 1740, and display a battery charging gauge 1751 on the second object 1760 on an LED member 1750. Alternatively, when a process of loading a character or character data is performed, the processor 120 may emit light through the LED member 1750. The processor 120 may display an image indicating that the character and content data is being loaded by rotating the light emitted from the LED member 1750.

According to an embodiment of the present disclosure, when a rechargeable transportation card or a gift card is mounted, the processor 120 may display a balance. Alternatively, when an object related to a game character is inserted while a game is being played, the processor 120 may display life energy of the game character on the LED member.

A computer-readable recording media may include a hard disk, a floppy disk, a magnetic media (e.g., a magnetic tape), an optical media (e.g., a compact disc-read only memory (CD-ROM) and/or digital versatile disk (DVD)), a magneto-optical media (e.g., a floptical disk), an internal memory, etc. An instruction may include a code made by a compiler or a code executable by an interpreter. A module or a program module according to an embodiment of the present disclosure may further include at least one or more of the aforementioned constituent elements, or omit some, or further include another constituent element. Operations carried out by a module, a program module or another constituent element according to an embodiment of the present disclosure may be executed in a sequential, parallel, repeated or heuristic method, or at least some operations may be executed in different order or may be omitted, or another operation may be added.

The embodiments of the present disclosure and drawings are specific embodiments to explain the technical features and assist in understanding, and do not limit the scope of the present disclosure. Therefore, the scope of the present disclosure is defined not by the detailed description of the disclosure but by the appended claims and their equivalents, and all differences within the scope will be construed as being included in the present disclosure.

What is claimed is:

1. An electronic device comprising:
a memory;
a display; and
a processor configured to:
detect a connection of an object;
detect a motion of an object connector connected with the object;
process a user interface corresponding to the motion; and
display the user interface on the display.

2. The electronic device of claim 1, further comprising a housing which is formed in at least one of an insertion type fastening structure, a slide type fastening structure, a fixed hole fastening structure, and a folding type fastening structure.

3. The electronic device of claim 2, wherein the processor is further configured to detect at least one of a motion distance, a rotation distance, a rotation angle, a motion speed, and a motion angle of the object connector based on the fastening structure.

4. The electronic device of claim 1, wherein the processor is further configured to detect a change in the motion of the object connector, and when the detected change in the motion corresponds to a predetermined level, displays a user interface corresponding to the predetermined level on the display.

5. The electronic device of claim 1, wherein the processor is further configured to determine a display area of the display based on the motion of the object connector.

6. The electronic device of claim 1, wherein the processor is further configured to determine at least one of an area, a size, and a type of an image related to the object based on the motion of the object connector.

7. The electronic device of claim 1, wherein the processor is further configured to determine an applying effect for a content displayed on the display, and apply the effect to the displayed content according to the motion of the object connector and the applying effect.

8. The electronic device of claim 7, wherein the processor is further configured to determine a target object for detecting the motion of the object connector based on at least one of the type of the content and the type of the object.

9. The electronic device of claim 7, wherein the effect is at least one of a change in color of an image related to the object, a change of an image, and a change of a location of an image.

10. The electronic device of claim 1, wherein, when the object is disconnected and a connection of another object is detected, the processor is further configured to display the user interface based on at least one of setting of the disconnected object, setting of another object, and settings of the electronic device.

11. A method of operating an electronic device, comprising:
detecting a connection of an object;
detecting a motion of an object connector connected with the object; and
processing a user interface corresponding to the detected motion and displaying the user interface on a display.

12. The method of claim 11, wherein detecting the connection of the object comprises detecting whether the object is connected to a housing which is formed in at least one of an insertion type fastening structure, a slide type fastening structure, a fixed hole fastening structure, and a folding type fastening structure.

13. The method of claim 12, wherein detecting the motion comprises detecting at least one of a motion distance, a rotation angle, a motion speed, and a motion angle of the object connector based on the fastening structure.

14. The method of claim 11, further comprising:
detecting a change in the motion of the object connector; and
when the detected change in the motion corresponds to a predetermined level, displaying a user interface corresponding to the predetermined level on the display.

15. The method of claim 11, wherein displaying on the display comprises determining a display area of the display based on the motion of the object connector.

16. The method of claim 11, wherein displaying on the display comprises determining at least one of an area, a size, and a type of an image related to the object based on the motion of the object connector.

17. The method of claim 11, further comprising:
determining an applying effect for a content displayed on the display; and
applying the effect to the displayed content according to the motion of the object connector and the applying effect.

18. The method of claim 17, further comprising determining a target object for detecting the motion of the object connector based on at least one of the type of the content and the type of the object.

19. The method of claim 17, wherein the effect is at least one of a change in color of an image related to the object, a change of an image, and a change of a location of an image.

20. The method of claim 11, further comprising:
disconnecting the object; and
when a connection of another object is detected, display the user interface based on at least one of setting of the disconnected object, setting of another object, and settings of the electronic device.
